(19) United States
(12) Patent Application Publication
(10) Pub. No.: US 2022/0254373 A1
(43) Pub. Date: Aug. 11, 2022

(54) MAGNETIC TAPE, MAGNETIC TAPE CARTRIDGE, AND MAGNETIC TAPE APPARATUS

(71) Applicant: FUJIFILM Corporation, Tokyo (JP)

(72) Inventors: Takuto Kurokawa, Minamiashigara-shi (JP); So Matsuyama, Minamiashigara-shi (JP); Norihito Kasada, Minamiashigara-shi (JP)

(73) Assignee: FUJIFILM Corporation, Tokyo (JP)

(21) Appl. No.: 17/666,851

(22) Filed: Feb. 8, 2022

(30) Foreign Application Priority Data
Feb. 9, 2021 (JP) 2021-018879

(51) Int. Cl. G11B 5/73; G11B 5/78

(52) U.S. Cl. CPC G11B 5/736; G11B 5/78

(57) ABSTRACT

The magnetic tape includes a non-magnetic support, and a magnetic layer including a ferromagnetic powder. A rate of change in friction coefficient on an LTO8 head measured on a surface of the magnetic layer before and after storage of the magnetic tape is 0.7 or more.

### CROSS-REFERENCE TO RELATED APPLICATIONS

This application claims priority under 35 U.S.C 119 to Japanese Patent Application No. 2021-018879 filed on Feb. 9, 2021. The above application is hereby expressly incorporated by reference, in its entirety, into the present application.

### BACKGROUND OF THE INVENTION

### 1. Field of the Invention

The present invention relates to a magnetic tape, a magnetic tape cartridge, and a magnetic tape apparatus.

### 2. Description of the Related Art

There are two types of magnetic recording media: a tape shape and a disk shape, and a tape-shaped magnetic recording medium, that is, a magnetic tape is mainly used for data storage applications such as data backup and archiving (for example, see JP6590104B).

### SUMMARY OF THE INVENTION

Recording of data on a magnetic tape is usually performed by running the magnetic tape in a magnetic tape apparatus (generally called a “drive”) and recording the data on a data band by making a magnetic head follow the data band of the magnetic tape. Thereby, a data track is formed in the data band. In addition, in a case where the recorded data is reproduced, the data recorded on the data band is read by running the magnetic tape in the magnetic tape apparatus and by making the magnetic head follow the data band of the magnetic tape.

In order to increase an accuracy of the magnetic head following the data band of the magnetic tape in recording and/or reproduction as described above, a system for performing head tracking using a servo signal (hereinafter, it is described as a “servo system”) has been put into practical use.

Further, dimension information in a width direction of the magnetic tape during running is acquired using the servo signal, and a tension applied in a longitudinal direction of the magnetic tape is adjusted according to the acquired dimension information, thereby controlling the dimension in the width direction of the magnetic tape (see, for example, paragraph 0170 of JP6590104B). It is considered that the above-described tension adjustment can contribute to suppression of occurrence of a phenomenon such as overwriting of recorded data and reproduction failure in a case where the magnetic head for recording or reproducing data deviates from a target track position due to width deformation of the magnetic tape during recording or reproduction. Further, in a case where the magnetic tape is run in the magnetic tape apparatus to record and/or reproduce data while performing such tension adjustment, it is expected that high running stability of the magnetic tape leads to further suppression of occurrence of the above phenomenon.

By the way, in recent years, the magnetic tape has been used in a data center where a temperature and a humidity are controlled.

On the other hand, the data center is required to save power in order to reduce costs. In order to save power, it is desirable that control conditions of the use environment of the magnetic tape in the data center can be more relaxed than a current level or the controlling can be made unnecessary.

However, in a case where the control conditions of the use environment are relaxed or the controlling is not performed, it is assumed that the magnetic tape may be used, for example, in a high temperature and high humidity environment. Therefore, a magnetic tape excellent in running stability in a case where recording and/or reproduction is performed by controlling the dimension in the width direction of the magnetic tape by adjusting the tension applied in the longitudinal direction of the magnetic tape in the high temperature and high humidity environment is desirable. In addition, JP6590104B does not disclose the use in the high temperature and high humidity environment.

An object of an aspect of the present invention is to provide a magnetic tape excellent in running stability in a case where recording and/or reproduction is performed by controlling a dimension in a width direction of the magnetic tape by adjusting a tension applied in a longitudinal direction of the magnetic tape in a high temperature and high humidity environment.

An aspect of the present invention relates to a magnetic tape comprising a non-magnetic support, and a magnetic layer including a ferromagnetic powder, in which a rate of change in friction coefficient on a linear tape-open (registered trademark: LTO) 8 head measured on a surface of the magnetic layer before and after storage of the magnetic tape, μ1/μ2, is 0.7 or more.

μ1 is a friction coefficient on an LTO8 head in a forward path during 10th reciprocating slide in a case where the magnetic tape is reciprocatively slid 3000 times with respect to the LTO8 head by applying a tension of 2.0 N (Newton) in a longitudinal direction of the magnetic tape in an environment of a temperature of 32° C. and a relative humidity of 80%.

μ2 is a friction coefficient on an LTO8 head in a forward path during 10th reciprocating slide in a case where the magnetic tape after the reciprocating slide of 3000 times is stored in the environment of the temperature of 32° C. and the relative humidity of 80% for 24 hours and then is reciprocatively slid 10 times with respect to the LTO8 head by applying the tension of 2.0 N in the longitudinal direction of the magnetic tape in the environment of the temperature of 32° C. and the relative humidity of 80%.

In an embodiment, μ1/μ2 may be 0.7 or more and 1.0 g or less.

In an embodiment, the magnetic layer may further include an inorganic oxide-based particle.

In an embodiment, the magnetic layer may further include carbon black.

In an embodiment, the magnetic tape may further comprise a non-magnetic layer including a non-magnetic powder between the non-magnetic support and the magnetic layer.

In an embodiment, the magnetic tape may further comprise a back coating layer including a non-magnetic powder on a surface side of the non-magnetic support opposite to a surface side having the magnetic layer.

In an embodiment, a tape thickness of the magnetic tape may be 5.3 μm or less.

In an embodiment, a vertical squareness ratio of the magnetic tape may be 0.60 or more.

Another aspect of the present invention relates to a magnetic tape cartridge comprising the magnetic tape described above.

Still another aspect of the present invention relates to a magnetic tape apparatus comprising the magnetic tape described above.

In an embodiment, the magnetic tape apparatus may further comprise a tension adjusting mechanism capable of adjusting the tension applied in the longitudinal direction of the magnetic tape running in the magnetic tape apparatus.

According to an aspect of the present invention, it is possible to provide a magnetic tape excellent in running stability in a case where recording and/or reproduction is performed by controlling a dimension in a width direction of the magnetic tape by adjusting a tension applied in a longitudinal direction of the magnetic tape in a high temperature and high humidity environment. In addition, according to an aspect of the present invention, it is possible to provide a magnetic tape cartridge and a magnetic tape apparatus which include the magnetic tape.

### BRIEF DESCRIPTION OF THE DRAWINGS

FIG. 1 shows an arrangement example of a data band and a servo band.

FIG. 2 shows an arrangement example of a servo pattern of a LTO Ultrium format tape.

FIG. 3 is a schematic view showing an example of a magnetic tape apparatus.

### DESCRIPTION OF THE PREFERRED EMBODIMENTS

Magnetic Tape

An aspect of the present invention relates to a magnetic tape including a non-magnetic support and a magnetic layer including a ferromagnetic powder. A rate of change (μ1/μ2) in friction coefficient on an LTO8 head measured on a surface of the magnetic layer before and after storage of the magnetic tape is 0.7 or more. In the present invention and the present specification, the “magnetic layer surface (surface of the magnetic layer)” has the same meaning as a surface of the magnetic tape on a magnetic layer side. μ1 is a friction coefficient on an LTO8 head in a forward path during 10th reciprocating slide in a case where the magnetic tape is reciprocatively slid 3000 times with respect to the LTO8 head by applying a tension of 2.0 N (Newton) in a longitudinal direction of the magnetic tape in an environment of a temperature of 32° C. and a relative humidity of 80%. μ2 is a friction coefficient on an LTO8 head in a forward path during 10th reciprocating slide in a case where the magnetic tape after the reciprocating slide of 3000 times is stored in the environment of the temperature of 32° C. and the relative humidity of 80% for 24 hours and then is reciprocatively slid 10 times with respect to the LTO8 head by applying the tension of 2.0 N in the longitudinal direction of the magnetic tape in the environment of the temperature of 32° C. and the relative humidity of 80%.

In a magnetic tape apparatus that controls a dimension in a width direction of the magnetic tape by adjusting the tension applied in the longitudinal direction of the magnetic tape, the larger the tension is applied in the longitudinal direction of the magnetic tape, the larger the dimension in the width direction of the magnetic tape can be shrunk (that is, the width can be made narrower), and the smaller the tension is, the smaller the degree of the shrunk can be. By adjusting the tension applied in the longitudinal direction of the magnetic tape in this manner, the dimension in the width direction of the magnetic tape can be controlled. In the following description, running stability in a case where recording and/or reproduction is performed by controlling the dimension in the width direction of the magnetic tape by adjusting the tension applied in the longitudinal direction of the magnetic tape will be simply referred to as “running stability”. In addition, the high temperature and high humidity environment may be, for example, an environment having a temperature of about 30° C. to 50° C. A humidity of the environment may be, for example, about 70% to 100% as a relative humidity. In the present invention and the present specification, the temperature and humidity described for an environment are an atmosphere temperature and a relative humidity of the environment.

On the other hand, recording of data on the magnetic tape and reproduction of the recorded data are usually performed as the magnetic layer surface of the magnetic tape and a magnetic head come into contact with each other to be slid on each other. The present inventor considered that in a case where the tension adjustment as described above is performed, a large tension may be applied in the longitudinal direction of the magnetic tape, which may be a factor of lowering running stability. In detail, the present inventor considered as follows. In a case where the magnetic tape runs repeatedly, a friction coefficient in a case where the magnetic tape comes into contact with the magnetic head tends to increase. This tendency can be remarkable in a case where a large tension is applied in the longitudinal direction of the magnetic tape while the magnetic tape is running. It is considered that this may be a factor for lowering the running stability, and it is considered that such lowering of the running stability may be more remarkable in a high temperature and high humidity environment.

In the course of repeated studies, the present inventor considered that in a case where the friction coefficient increased by the above repeated running can be brought close to the value before the increase in a short period of time (hereinafter, also referred to as “early recovery of friction characteristics”), the running stability lowered by the repeated running can be improved in an early stage, and further conducted intensive studies. In a case where early recovery of friction characteristics is possible, for example, even though an interval from the end of recording to the next recording or an interval from the end of recording to reproduction is shortened, recording or reproduction can be performed by stably running the magnetic tape.

As a result of such intensive studies, the present inventor newly found that the magnetic tape in which the rate of change (μ1/μ2) in friction coefficient on the LTO8 head before and after storage of the magnetic tape, which is measured by applying the tension of 2.0 N in the longitudinal direction of the magnetic tape in the environment of the temperature of 32° C. and the relative humidity of 80%, is 0.7 or more can recover the friction characteristics in an early stage, thereby making it possible to stably run the magnetic tape in a short period of time after repeated running in a case where recording and/or reproduction is performed by controlling the dimension in the width direction of the magnetic tape by adjusting the tension applied in the longitudinal direction of the magnetic tape in the high temperature and high humidity environment. The temperature and humidity of the measurement environment and the storage environment are employed as exemplary values of the temperature and humidity of the high temperature and high humidity environment. Therefore, an environment in which data is recorded on the magnetic tape and the recorded data is reproduced and an environment in which the magnetic tape is stored are not limited to the temperature and humidity environment. The tension applied in the longitudinal direction of the magnetic tape in a case of measuring the friction coefficient is also employed as an exemplary value of the large tension that can be applied in the longitudinal direction of the magnetic tape in a case where the tension adjustment as described above is performed. Therefore, the tension applied in the longitudinal direction of the magnetic tape in a case where data is recorded on the magnetic tape and the recorded data is reproduced is not limited to the above tension. In addition, the present invention is not limited by supposition of the present inventor described in the present specification.

In the present invention and the present specification, the friction coefficient μ1 is a value to be measured by the following method in an environment of a temperature of 32° C. and a relative humidity of 80%.

The magnetic tape to be measured is attached to a reel tester comprising two reels and two guide rolls. In the reel tester, the magnetic tape to be measured is placed on two cylindrical guide rolls having a diameter of 1 inch (1 inch=2.54 cm) spaced apart from each other and arranged in parallel with each other such that the magnetic layer surface thereof is in contact with the guide rolls. Before the measurement of the friction coefficient μ1, the magnetic tape to be measured is placed on the guide roll as described above and left for 24 hours in order to be adapted to the measurement environment. In a randomly extracted portion of the magnetic tape to be measured, the magnetic layer surface of the magnetic tape and the LTO8 head come into contact with other to be slid on each other, and a resistance force generated during the sliding is detected by a strain gauge. Reciprocating slide of the magnetic tape is performed 3000 times by repeating feeding from one reel and winding to the other reel between the two reels. Regarding measurement conditions, a lap angle θ is set to 4° and a sliding speed is set to 4.0 m/sec. A tension T₀ (unit: N) applied in the longitudinal direction of the magnetic tape during the sliding is set to 2.0 N. A sliding distance for each of a forward path and a return path is set to 20 m. The friction coefficient in the forward path during 10th reciprocating slide is used as the friction coefficient μ1 before storage. Specifically, the friction coefficient μ1 before storage is obtained as follows. In a case of measurement, the LTO8 head is connected to the strain gauge, and a frictional force F (unit: N) applied in the horizontal direction with respect to the LTO8 head is acquired. T₀ is 2.0. The friction coefficient μ is calculated by Expression A. The calculated friction coefficient μ is used as the friction coefficient μ1 before storage.

$$μ = \frac{1}{sin ( \frac{θ}{2} )} \times \frac{F}{{T}_{0}} \qquad Expression A$$

In the present invention and the present specification, the friction coefficient μ2 is a value to be measured by the following method in an environment of a temperature of 32° C. and a relative humidity of 80%.

The magnetic tape after the reciprocating slide of 3000 times is continuously stored in the same environment (that is, the environment of the temperature of 32° C. and the relative humidity of 80%) for 24 hours in a state where the entire length of the magnetic tape is wound around one of the two reels. Within 1 hour after the 24-hours storage, the magnetic tape after the storage is attached to the reel tester in the same environment (that is, the environment of the temperature of 32° C. and the relative humidity of 80%) as described above and is reciprocatively slid 10 times under the same measurement conditions. Here, the portion that has been reciprocatively slid for measuring the friction coefficient μ1 is reciprocatively slid. The friction coefficient μ in the forward path during 10th reciprocating slide is calculated by the same expression A as described above. The calculated μ is used as the friction coefficient μ2 after storage.

In the present invention and the present specification, the rate of change (μ1/μ2) in friction coefficient on the LTO8 head measured on the surface of the magnetic layer of the magnetic tape before and after storage of the magnetic tape is calculated from μ1 and μ2 obtained by the above method. In the following description, the rate of change (μ1/μ2) is also be referred to as a “rate of change (μ1/μ2) in friction coefficient before and after storage of the magnetic tape”.

In the present invention and the present specification, the term “LTO8 head” refers to a magnetic head conforming to an LTO8 standard. For the measurement of the friction coefficient, a magnetic head mounted on an LTO8 drive may be taken out and used, or a commercially available magnetic head as the magnetic head for the LTO8 drive may be used. Here, the LTO8 drive is a drive (magnetic tape apparatus) conforming to an LTO8 standard. An LTO9 drive is a drive conforming to an LTO9 standard, and the same applies to drives of other generations. In addition, a new (that is, unused) LTO8 head is used for the measurement of the friction coefficient μ1. For the measurement of the friction coefficient μ2, the LTO8 head used for the measurement of the friction coefficient μ1 is continuously used. In consideration of the fact that the LTO8 standard is a standard that can cope with high-density recording in recent years, the LTO8 is employed as a magnetic head for measuring the friction coefficient, and the magnetic tape is not limited to the one used in the LTO8 drive. On the magnetic tape, data may be recorded and/or reproduced in the LTO8 drive, data may be recorded and/or reproduced in the LTO9 drive or even a next generation drive, or data may be recorded and/or reproduced in a drive of a generation prior to the LTO8 drive, such as LTO7.

Rate of Change (μ1/μ2) in Friction Coefficient before and after Storage of Magnetic Tape

Regarding the friction characteristics of the magnetic tape, from the viewpoint of improving the running stability in a case where recording and/or reproduction is performed by controlling the dimension in the width direction of the magnetic tape by adjusting the tension applied in the longitudinal direction of the magnetic tape in the high temperature and high humidity environment, the rate of change (μ1/μ2) in friction coefficient before and after storage of the magnetic tape is 0.7 or more, preferably 0.8 or more, and more preferably 0.9 or more. The rate of change (μ1/μ2) in friction coefficient before and after storage of the magnetic tape may be, for example, 1.0 or less, less than 1.0, or 0.9 or less. It is preferable that a value of the rate of change (μ1/μ2) in friction coefficient before and after storage of the magnetic tape is closer to 1.0, because it can mean that the friction coefficient increased by repeated running can be brought closer to the value before the increase in a short period of time. The friction coefficient μ1 and the friction coefficient μ2 may be, for example, 0.5 or more, 0.7 or more, or 0.9 or more, and 0.9 or less, or 0.8 or less, respectively. The friction characteristics of the magnetic tape can be adjusted, for example, by the type of components used to manufacture the magnetic layer, the preparation method of a magnetic layer forming composition, and the like. Details of this point will be described below.

Vertical Squareness Ratio

In an aspect, a vertical squareness ratio of the magnetic tape may be, for example, 0.55 or more, and is preferably 0.60 or more. From the viewpoint of improving the electromagnetic conversion characteristics, it is preferable that the vertical squareness ratio of the magnetic tape is 0.60 or more. In principle, the upper limit of the squareness ratio is 1.00 or less. The vertical squareness ratio of the magnetic tape may be 1.00 or less, 0.95 or less, 0.90 or less, 0.85 or less, or 0.80 or less. From the viewpoint of improving the electromagnetic conversion characteristics, a large value of the vertical squareness ratio of the magnetic tape is preferable. The vertical squareness ratio of the magnetic tape can be controlled by a well-known method such as performing a vertical alignment treatment.

In the present invention and the present specification, the term “vertical squareness ratio” refers to a squareness ratio measured in the vertical direction of the magnetic tape. The term “vertical direction” described regarding the squareness ratio refers to a direction orthogonal to the magnetic layer surface, and can also be referred to as a thickness direction. In the present invention and the present specification, the vertical squareness ratio is obtained by the following method.

A sample piece having a size capable of being introduced into a vibrating sample magnetometer is cut out from the magnetic tape to be measured. For this sample piece, using a vibrating sample magnetometer, a magnetic field is applied in the vertical direction (direction orthogonal to the magnetic layer surface) of the sample piece at a maximum applied magnetic field of 3979 kA/m, a measurement temperature of 296 K, and a magnetic field sweeping speed of 8.3 kA/m/sec, and the magnetization strength of the sample piece with respect to the applied magnetic field is measured. The measured value of the magnetization strength is obtained as a value after demagnetic field correction and as a value obtained by subtracting the magnetization of a sample probe of the vibrating sample magnetometer as a background noise. Assuming that the magnetization strength at the maximum applied magnetic field is Ms and the magnetization strength at zero applied magnetic field is Mr, a squareness ratio SQ is a value calculated as SQ=Mr/Ms. The measurement temperature refers to a temperature of the sample piece, and by setting an atmosphere temperature around the sample piece to the measurement temperature, the temperature of the sample piece can be set to the measurement temperature by establishing a temperature equilibrium.

Hereinafter, the magnetic tape will be described in more detail.

Magnetic Layer

Ferromagnetic Powder

As a ferromagnetic powder included in the magnetic layer, a well-known ferromagnetic powder as a ferromagnetic powder used in magnetic layers of various magnetic recording media can be used alone or in combination of two or more. From the viewpoint of improving the recording density, it is preferable to use a ferromagnetic powder having a small average particle size. From this point, the average particle size of the ferromagnetic powder is preferably 50 nm or less, more preferably 45 nm or less, still more preferably 40 nm or less, still more preferably 35 nm or less, still more preferably 30 nm or less, still more preferably 25 nm or less, and still more preferably 20 nm or less. On the other hand, from the viewpoint of the magnetization stability, the average particle size of the ferromagnetic powder is preferably 5 nm or more, more preferably 8 nm or more, still more preferably 10 nm or more, still more preferably 15 nm or more, and still more preferably 20 nm or more.

Hexagonal Ferrite Powder

Preferred specific examples of the ferromagnetic powder include a hexagonal ferrite powder. For details of the hexagonal ferrite powder, for example, descriptions disclosed in paragraphs 0012 to 0030 of JP2011-225417A, paragraphs 0134 to 0136 of JP2011-216149A, paragraphs 0013 to 0030 of JP2012-204726A, and paragraphs 0029 to 0084 of JP2015-127985A can be referred to.

In the present invention and the present specification, the term “hexagonal ferrite powder” refers to a ferromagnetic powder in which a hexagonal ferrite type crystal structure is detected as a main phase by X-ray diffraction analysis. The main phase refers to a structure to which the highest intensity diffraction peak in an X-ray diffraction spectrum obtained by X-ray diffraction analysis is attributed. For example, in a case where the highest intensity diffraction peak is attributed to a hexagonal ferrite type crystal structure in an X-ray diffraction spectrum obtained by X-ray diffraction analysis, it is determined that the hexagonal ferrite type crystal structure is detected as the main phase. In a case where only a single structure is detected by X-ray diffraction analysis, this detected structure is taken as the main phase. The hexagonal ferrite type crystal structure includes at least an iron atom, a divalent metal atom, and an oxygen atom, as a constituent atom. The divalent metal atom is a metal atom that can be a divalent cation as an ion, and examples thereof may include an alkaline earth metal atom such as a strontium atom, a barium atom, and a calcium atom, and a lead atom. In the present invention and the present specification, a hexagonal strontium ferrite powder refers to a powder in which a main divalent metal atom is a strontium atom, and a hexagonal barium ferrite powder refers to a powder in which a main divalent metal atom is a barium atom. The main divalent metal atom refers to a divalent metal atom that accounts for the most on an at % basis among the divalent metal atoms included in the powder. Here, a rare earth atom is not included in the above divalent metal atom. The term “rare earth atom” in the present invention and the present specification refers to an atom selected from the group consisting of a scandium atom (Sc), an yttrium atom (Y), and a lanthanoid atom. The lanthanoid atom is selected from the group consisting of a lanthanum atom (La), a cerium atom (Ce), a praseodymium atom (Pr), a neodymium atom(Nd), a promethium atom (Pm), a samarium atom (Sm), a europium atom (Eu), a gadolinium atom (Gd), a terbium atom (Tb), a dysprosium atom (Dy), a holmium atom (Ho), an erbium atom (Er), a thulium atom (Tm), an ytterbium atom (Yb), and a lutetium atom (Lu).

Hereinafter, the hexagonal strontium ferrite powder, which is an aspect of the hexagonal ferrite powder, will be described in more detail.

An activation volume of the hexagonal strontium ferrite powder is preferably in a range of 800 to 1600 nm³. The finely granulated hexagonal strontium ferrite powder having an activation volume in the above range is suitable for manufacturing a magnetic tape exhibiting excellent electromagnetic conversion characteristics. The activation volume of the hexagonal strontium ferrite powder is preferably 800 nm³ or more, and may be, for example, 850 nm³ or more. Further, from the viewpoint of further improving the electromagnetic conversion characteristics, the activation volume of the hexagonal strontium ferrite powder is more preferably 1500 nm³ or less, still more preferably 1400 nm³ or less, still more preferably 1300 nm³ or less, still more preferably 1200 nm³ or less, and still more preferably 1100 nm³ or less. The same applies to an activation volume of the hexagonal barium ferrite powder.

The term “activation volume” refers to a unit of magnetization reversal and is an index indicating the magnetic size of a particle. An activation volume described in the present invention and the present specification and an anisotropy constant Ku which will be described below are values obtained from the following relational expression between a coercivity He and an activation volume V, by performing measurement in a coercivity He measurement portion at a magnetic field sweep rate of 3 minutes and 30 minutes using a vibrating sample magnetometer (measurement temperature: 23° C. P° C.). For a unit of the anisotropy constant Ku, 1 erg/cc=1.0×10⁻¹ J/m³.

Hc=2Ku/Ms{1−[(kT/KuV)ln(At/0.693)]^{1/2}}

[In the above expression, Ku: anisotropy constant (unit: J/m³), Ms: saturation magnetization (unit: kA/m), k: Boltzmann constant, T: absolute temperature (unit: K), V: activation volume (unit: cm³), A: spin precession frequency (unit: s⁻¹), t: magnetic field reversal time (unit: s)]

An index for reducing thermal fluctuation, in other words, for improving the thermal stability may include the anisotropy constant Ku. The hexagonal strontium ferrite powder preferably has Ku of 1.8×10⁵ J/m³ or more, and more preferably has Ku of 2.0×10¹ J/m³ or more. Ku of the hexagonal strontium ferrite powder may be, for example, 2.5×10 J/m³ or less. Here, since higher Ku means higher thermal stability, which is preferable, a value thereof is not limited to the values exemplified above.

The hexagonal strontium ferrite powder may or may not include a rare earth atom. In a case where the hexagonal strontium ferrite powder includes a rare earth atom, it is preferable to include a rare earth atom at a content (bulk content) of 0.5 to 5.0 at % with respect to 100 at % of an iron atom. In an aspect, the hexagonal strontium ferrite powder including a rare earth atom may have a rare earth atom surface layer portion uneven distribution property. In the present invention and the present specification, the “rare earth atom surface layer portion uneven distribution property” means that a rare earth atom content with respect to 100 at % of an iron atom in a solution obtained by partially dissolving the hexagonal strontium ferrite powder with an acid (hereinafter, referred to as a “rare earth atom surface layer portion content” or simply a “surface layer portion content” for a rare earth atom.) and a rare earth atom content with respect to 100 at % of an iron atom in a solution obtained by totally dissolving the hexagonal strontium ferrite powder with an acid (hereinafter, referred to as a “rare earth atom bulk content” or simply a “bulk content” for a rare earth atom.) satisfy a ratio of a rare earth atom surface layer portion content/a rare earth atom bulk content >1.0. A rare earth atom content in the hexagonal strontium ferrite powder which will be described below has the same meaning as the rare earth atom bulk content. On the other hand, partial dissolution using an acid dissolves a surface layer portion of a particle constituting the hexagonal strontium ferrite powder, and thus, a rare earth atom content in a solution obtained by partial dissolution is a rare earth atom content in a surface layer portion of a particle constituting the hexagonal strontium ferrite powder. A rare earth atom surface layer portion content satisfying a ratio of “rare earth atom surface layer portion content/rare earth atom bulk content >1.0” means that in a particle constituting the hexagonal strontium ferrite powder, rare earth atoms are unevenly distributed in a surface layer portion (that is, more than an inside). The surface layer portion in the present invention and the present specification means a partial region from a surface of a particle constituting the hexagonal strontium ferrite powder toward an inside.

In a case where the hexagonal strontium ferrite powder includes a rare earth atom, a rare earth atom content (bulk content) is preferably in a range of 0.5 to 5.0 at % with respect to 100 at % of an iron atom. It is considered that a bulk content in the above range of the included rare earth atom and uneven distribution of the rare earth atoms in a surface layer portion of a particle constituting the hexagonal strontium ferrite powder contribute to suppression of a decrease in reproduction output during repeated reproduction. It is supposed that this is because the hexagonal strontium ferrite powder includes a rare earth atom with a bulk content in the above range, and rare earth atoms are unevenly distributed in a surface layer portion of a particle constituting the hexagonal strontium ferrite powder, and thus it is possible to increase an anisotropy constant Ku. The higher a value of an anisotropy constant Ku is, the more a phenomenon called so-called thermal fluctuation can be suppressed (in other words, thermal stability can be improved). By suppressing occurrence of thermal fluctuation, it is possible to suppress a decrease in reproduction output during repeated reproduction. It is supposed that uneven distribution of rare earth atoms in a particulate surface layer portion of the hexagonal strontium ferrite powder contributes to stabilization of spins of iron (Fe) sites in a crystal lattice of a surface layer portion, and thus, an anisotropy constant Ku may be increased.

Moreover, it is supposed that the use of the hexagonal strontium ferrite powder having a rare earth atom surface layer portion uneven distribution property as a ferromagnetic powder in the magnetic layer also contributes to inhibition of a magnetic layer surface from being scraped by being slid with respect to the magnetic head. That is, it is supposed that the hexagonal strontium ferrite powder having a rare earth atom surface layer portion uneven distribution property can also contribute to an improvement of running durability of the magnetic tape. It is supposed that this may be because uneven distribution of rare earth atoms on a surface of a particle constituting the hexagonal strontium ferrite powder contributes to an improvement of interaction between the particle surface and an organic substance (for example, a binding agent and/or an additive) included in the magnetic layer, and, as a result, a strength of the magnetic layer is improved.

From the viewpoint of suppressing a decrease in reproduction output during repeated reproduction and/or the viewpoint of further improving running durability, the rare earth atom content (bulk content) is more preferably in a range of 0.5 to 4.5 at %, still more preferably in a range of 1.0 to 4.5 at %, and still more preferably in a range of 1.5 to 4.5 at %.

The bulk content is a content obtained by totally dissolving the hexagonal strontium ferrite powder. In the present invention and the present specification, unless otherwise noted, the content of an atom means a bulk content obtained by totally dissolving the hexagonal strontium ferrite powder. The hexagonal strontium ferrite powder including a rare earth atom may include only one kind of rare earth atom as the rare earth atom, or may include two or more kinds of rare earth atoms. The bulk content in the case of including two or more types of rare earth atoms is obtained for the total of two or more types of rare earth atoms. This also applies to other components in the present invention and the present specification. That is, unless otherwise noted, a certain component may be used alone or in combination of two or more. A content amount or a content in a case where two or more components are used refers to that for the total of two or more components.

In a case where the hexagonal strontium ferrite powder includes a rare earth atom, the included rare earth atom need only be any one or more of rare earth atoms. As a rare earth atom that is preferable from the viewpoint of suppressing a decrease in reproduction output during repeated reproduction, there are a neodymium atom, a samarium atom, a yttrium atom, and a dysprosium atom, here, the neodymium atom, the samarium atom, and the yttrium atom are more preferable, and a neodymium atom is still more preferable.

In the hexagonal strontium ferrite powder having a rare earth atom surface layer portion uneven distribution property, the rare earth atoms need only be unevenly distributed in the surface layer portion of a particle constituting the hexagonal strontium ferrite powder, and the degree of uneven distribution is not limited. For example, for a hexagonal strontium ferrite powder having a rare earth atom surface layer portion uneven distribution property, a ratio of a surface layer portion content of a rare earth atom obtained by partial dissolution under dissolution conditions which will be described below to a bulk content of a rare earth atom obtained by total dissolution under dissolution conditions which will be described below, that is, “surface layer portion content/bulk content” exceeds 1.0 and may be 1.5 or more. The fact that “surface layer portion content/bulk content” is larger than 1.0 means that in a particle constituting the hexagonal strontium ferrite powder, rare earth atoms are unevenly distributed in the surface layer portion (that is, more than an inside). Further, a ratio of a surface layer portion content of a rare earth atom obtained by partial dissolution under dissolution conditions which will be described below to a bulk content of a rare earth atom obtained by total dissolution under the dissolution conditions which will be described below, that is, “surface layer portion content/bulk content” may be, for example, 10.0 or less, 9.0 or less, 8.0 or less, 7.0 or less, 6.0 or less, 5.0 or less, or 4.0 or less. Here, in the hexagonal strontium ferrite powder having a rare earth atom surface layer portion uneven distribution property, the rare earth atoms need only be unevenly distributed in the surface layer portion of a particle constituting the hexagonal strontium ferrite powder, and “surface layer portion content/bulk content” is not limited to the exemplified upper limit or lower limit.

The partial dissolution and the total dissolution of the hexagonal strontium ferrite powder will be described below. For the hexagonal strontium ferrite powder that exists as a powder, the partially and totally dissolved sample powder is taken from the same lot of powder. On the other hand, for the hexagonal strontium ferrite powder included in the magnetic layer of the magnetic tape, a part of the hexagonal strontium ferrite powder taken out from the magnetic layer is subjected to partial dissolution, and the other part is subjected to total dissolution. The hexagonal strontium ferrite powder can be taken out from the magnetic layer by a method described in a paragraph 0032 of JP2015-91747A, for example.

The partial dissolution means that dissolution is performed such that, at the end of dissolution, the residue of the hexagonal strontium ferrite powder can be visually checked in the solution. For example, by partial dissolution, it is possible to dissolve a region of 10 to 20 mass % of the particle constituting the hexagonal strontium ferrite powder with the total particle being 100 mass %. On the other hand, the total dissolution means that dissolution is performed such that, at the end of dissolution, the residue of the hexagonal strontium ferrite powder cannot be visually checked in the solution.

The partial dissolution and measurement of the surface layer portion content are performed by the following method, for example. Here, the following dissolution conditions such as the amount of sample powder are exemplified, and dissolution conditions for partial dissolution and total dissolution can be employed in any manner.

A container (for example, a beaker) containing 12 mg of the sample powder and 10 mL of 1 mol/L hydrochloric acid is held on a hot plate at a set temperature of 70° C. for 1 hour. The obtained solution is filtered by a membrane filter of 0.1 μm. Elemental analysis of the filtrated solution is performed by an inductively coupled plasma (ICP) analyzer. In this way, the surface layer portion content of a rare earth atom with respect to 100 at % of an iron atom can be obtained. In a case where a plurality of types of rare earth atoms are detected by elemental analysis, the total content of all rare earth atoms is defined as the surface layer portion content. This also applies to the measurement of the bulk content.

On the other hand, the total dissolution and measurement of the bulk content are performed by the following method, for example.

A container (for example, a beaker) containing 12 mg of the sample powder and 10 mL of 4 mol/L hydrochloric acid is held on a hot plate at a set temperature of 80° C. for 3 hours. Thereafter, the same procedure as the partial dissolution and the measurement of the surface layer portion content is carried out, and the bulk content with respect to 100 at % of an iron atom can be obtained.

From the viewpoint of increasing the reproduction output in a case of reproducing data recorded on the magnetic tape, it is desirable that mass magnetization as of the ferromagnetic powder included in the magnetic tape is high. In this regard, the hexagonal strontium ferrite powder including a rare earth atom but not having the rare earth atom surface layer portion uneven distribution property tends to have a larger decrease in as than that of the hexagonal strontium ferrite powder including no rare earth atom. With respect to this, it is considered that the hexagonal strontium ferrite powder having a rare earth atom surface layer portion uneven distribution property is preferable in suppressing such a large decrease in as. In an aspect, as of the hexagonal strontium ferrite powder may be 45 A·m²/kg or more, and may be 47 A·m²/kg or more. On the other hand, from the viewpoint of noise reduction, as is preferably 80 A·m²/kg or less and more preferably 60 A·m²/kg or less. σs can be measured using a well-known measuring device, such as a vibrating sample magnetometer, capable of measuring magnetic properties. In the present invention and the present specification, unless otherwise noted, the mass magnetization as is a value measured at a magnetic field intensity of 15 kOe. 1 [kOe] is 10⁶/4π [A/m].

Regarding the content (bulk content) of a constituent atom of the hexagonal strontium ferrite powder, a strontium atom content may be, for example, in a range of 2.0 to 15.0 at % with respect to 100 at % of an iron atom. In an aspect, the hexagonal strontium ferrite powder may include only a strontium atom as a divalent metal atom. In another aspect, the hexagonal strontium ferrite powder may include one or more other divalent metal atoms in addition to a strontium atom. For example, a barium atom and/or a calcium atom may be included. In a case where divalent metal atoms other than a strontium atom are included, a barium atom content and a calcium atom content in the hexagonal strontium ferrite powder are, for example, in a range of 0.05 to 5.0 at % with respect to 100 at % of an iron atom.

As a crystal structure of hexagonal ferrite, a magnetoplumbite type (also referred to as an “M type”), a W type, a Y type, and a Z type are known. The hexagonal strontium ferrite powder may have any crystal structure. The crystal structure can be checked by X-ray diffraction analysis. In the hexagonal strontium ferrite powder, a single crystal structure or two or more crystal structures may be detected by X-ray diffraction analysis. For example, according to an aspect, in the hexagonal strontium ferrite powder, only the M-type crystal structure may be detected by X-ray diffraction analysis. For example, M-type hexagonal ferrite is represented by a composition formula of AFe₁₂O₁₉. Here, A represents a divalent metal atom, and in a case where the hexagonal strontium ferrite powder is the M-type, A is only a strontium atom (Sr), or in a case where, as A, a plurality of divalent metal atoms are included, as described above, a strontium atom (Sr) accounts for the most on an at % basis. The divalent metal atom content of the hexagonal strontium ferrite powder is usually determined by the type of crystal structure of the hexagonal ferrite and is not particularly limited. The same applies to the iron atom content and the oxygen atom content. The hexagonal strontium ferrite powder may include at least an iron atom, a strontium atom, and an oxygen atom, and may further include a rare earth atom. Furthermore, the hexagonal strontium ferrite powder may or may not include atoms other than these atoms. As an example, the hexagonal strontium ferrite powder may include an aluminum atom (Al). A content of an aluminum atom may be, for example, 0.5 to 10.0 at % with respect to 100 at % of an iron atom. From the viewpoint of suppressing a decrease in reproduction output during repeated reproduction, the hexagonal strontium ferrite powder includes an iron atom, a strontium atom, an oxygen atom, and a rare earth atom, and the content of atoms other than these atoms is preferably 10.0 at % or less, more preferably in a range of 0 to 5.0 at %, and may be 0 at % with respect to 100 at % of an iron atom. That is, in an aspect, the hexagonal strontium ferrite powder may not include atoms other than an iron atom, a strontium atom, an oxygen atom, and a rare earth atom. The content expressed in at % is obtained by converting a content of each atom (unit: mass %) obtained by totally dissolving the hexagonal strontium ferrite powder into a value expressed in at % using an atomic weight of each atom. Further, in the present invention and the present specification, the term “not include” for a certain atom means that a content measured by an ICP analyzer after total dissolution is 0 mass %. A detection limit of the ICP analyzer is usually 0.01 parts per million (ppm) or less on a mass basis. The term “not included” is used as a meaning including that an atom is included in an amount less than the detection limit of the ICP analyzer. In an aspect, the hexagonal strontium ferrite powder may not include a bismuth atom (Bi).

Metal Powder

Preferred specific examples of the ferromagnetic powder include a ferromagnetic metal powder. For details of the ferromagnetic metal powder, for example, descriptions disclosed in paragraphs 0137 to 0141 of JP2011-216149A and paragraphs 0009 to 0023 of JP2005-251351A can be referred to.

ε-Iron Oxide Powder

Preferred specific examples of the ferromagnetic powder include an ε-iron oxide powder. In the present invention and the present specification, the term “ε-iron oxide powder” refers to a ferromagnetic powder in which an ε-iron oxide type crystal structure is detected as a main phase by X-ray diffraction analysis. For example, in a case where the highest intensity diffraction peak is attributed to an ε-iron oxide type crystal structure in an X-ray diffraction spectrum obtained by X-ray diffraction analysis, it is determined that the ε-iron oxide type crystal structure is detected as the main phase. As a method of manufacturing the s-iron oxide powder, a producing method from a goethite, a reverse micelle method, and the like are known. All of the manufacturing methods are well known. Regarding a method of manufacturing an ε-iron oxide powder in which a part of Fe is substituted with substitutional atoms such as Ga, Co, Ti, Al, or Rh, a description disclosed in J. Jpn. Soc. Powder Metallurgy Vol. 61 Supplement, No. S1, pp. S280 to S284, J. Mater. Chem. C, 2013, 1, pp. 5200 to 5206 can be referred to, for example. Here, the method of manufacturing the ε-iron oxide powder capable of being used as the ferromagnetic powder in the magnetic layer of the magnetic tape is not limited to the methods described here.

An activation volume of the ε-iron oxide powder is preferably in a range of 300 to 1500 nm³. The finely granulated ε-iron oxide powder having an activation volume in the above range is suitable for manufacturing a magnetic tape exhibiting excellent electromagnetic conversion characteristics. The activation volume of the ε-iron oxide powder is preferably 300 nm³ or more, and may be, for example, 500 nm³ or more. Further, from the viewpoint of further improving the electromagnetic conversion characteristics, the activation volume of the ε-iron oxide powder is more preferably 1400 nm³ or less, still more preferably 1300 nm³ or less, still more preferably 1200 nm³ or less, and still more preferably 1100 nm³ or less.

An index for reducing thermal fluctuation, in other words, for improving the thermal stability may include the anisotropy constant Ku. The ε-iron oxide powder preferably has Ku of 3.0×10⁴ J/m³ or more, and more preferably has Ku of 8.0×10¹ J/m³ or more. Ku of the ε-iron oxide powder may be, for example, 3.0×10⁵ J/m³ or less. Here, since higher Ku means higher thermal stability, which is preferable, a value thereof is not limited to the values exemplified above.

From the viewpoint of increasing the reproduction output in a case of reproducing data recorded on the magnetic tape, it is desirable that mass magnetization as of the ferromagnetic powder included in the magnetic tape is high. In this regard, in an aspect, as of the ε-iron oxide powder may be 8 A·m/kg or more, and may be 12 A·m²/kg or more. On the other hand, from the viewpoint of noise reduction, as of the ε-iron oxide powder is preferably 40 A·m²/kg or less and more preferably 35 A·m²/kg or less.

In the present invention and the present specification, unless otherwise noted, an average particle size of various powders such as ferromagnetic powders is a value measured by the following method using a transmission electron microscope.

The powder is imaged at an imaging magnification of 100000 using a transmission electron microscope, and the image is printed on printing paper such that the total magnification is 500000 to obtain an image of particles constituting the powder. A target particle is selected from the obtained image of particles, an outline of the particle is traced by a digitizer, and a size of the particle (primary particle) is measured. The primary particles are independent particles without aggregation.

The measurement described above is performed regarding 500 particles randomly extracted. An arithmetic average of the particle sizes of 500 particles thus obtained is an average particle size of the powder. As the transmission electron microscope, a transmission electron microscope H-9000 manufactured by Hitachi, Ltd. can be used, for example. In addition, the measurement of the particle size can be performed by well-known image analysis software, for example, image analysis software KS-400 manufactured by Carl Zeiss. An average particle size shown in Examples which will be described below is a value measured by using a transmission electron microscope H-9000 manufactured by Hitachi, Ltd. as the transmission electron microscope, and image analysis software KS-400 manufactured by Carl Zeiss as the image analysis software, unless otherwise noted. In the present invention and the present specification, the powder means an aggregate of a plurality of particles. For example, the ferromagnetic powder means an aggregate of a plurality of ferromagnetic particles. Further, the aggregate of the plurality of particles not only includes an aspect in which particles constituting the aggregate directly come into contact with each other, but also includes an aspect in which a binding agent or an additive which will be described below is interposed between the particles. The term “particle” is used to describe a powder in some cases.

As a method of taking a sample powder from the magnetic tape in order to measure the particle size, a method disclosed in a paragraph 0015 of JP2011-048878A can be used, for example.

In the present invention and the present specification, unless otherwise noted. (1) in a case where the shape of the particle observed in the particle image described above is a needle shape, a fusiform shape, or a columnar shape (here, a height is greater than a maximum long diameter of a bottom surface), the size (particle size) of the particles constituting the powder is shown as a length of a long axis configuring the particle, that is, a long axis length, (2) in a case where the shape of the particle is a plate shape or a columnar shape (here, a thickness or a height is smaller than a maximum long diameter of a plate surface or a bottom surface), the particle size is shown as a maximum long diameter of the plate surface or the bottom surface, and (3) in a case where the shape of the particle is a sphere shape, a polyhedron shape, or an amorphous shape, and the long axis configuring the particles cannot be specified from the shape, the particle size is shown as an equivalent circle diameter. The equivalent circle diameter is a value obtained by a circle projection method.

In addition, regarding an average acicular ratio of the powder, a length of a short axis, that is, a short axis length of the particles is measured in the measurement described above, a value of (long axis length/short axis length) of each particle is obtained, and an arithmetic average of the values obtained regarding 500 particles is calculated. Here, unless otherwise noted, in a case of (1), the short axis length as the definition of the particle size is a length of a short axis configuring the particle, in a case of (2), the short axis length is a thickness or a height, and in a case of (3), the long axis and the short axis are not distinguished, thus, the value of (long axis length/short axis length) is assumed as 1, for convenience.

In addition, unless otherwise noted, in a case where the shape of the particle is specified, for example, in a case of definition of the particle size (1), the average particle size is an average long axis length, and in a case of the definition (2), the average particle size is an average plate diameter. In a case of the definition (3), the average particle size is an average diameter (also referred to as an average particle diameter).

The content (filling percentage) of the ferromagnetic powder of the magnetic layer is preferably in a range of 50 to 90 mass % and more preferably in a range of 60 to 90 mass %. A high filling percentage of the ferromagnetic powder in the magnetic layer is preferable from the viewpoint of improving the recording density.

Binding Agent

The magnetic tape can be a coating type magnetic tape, and include a binding agent in the magnetic layer. The binding agent is one or more resins. As the binding agent, various resins usually used as a binding agent of a coating type magnetic recording medium can be used. For example, as the binding agent, a resin selected from a polyurethane resin, a polyester resin, a polyamide resin, a vinyl chloride resin, an acrylic resin obtained by copolymerizing styrene, acrylonitrile, or methyl methacrylate, a cellulose resin such as nitrocellulose, an epoxy resin, a phenoxy resin, and a polyvinylalkylal resin such as polyvinyl acetal or polyvinyl butyral can be used alone or a plurality of resins can be mixed with each other to be used. Among these, a polyurethane resin, an acrylic resin, a cellulose resin, and a vinyl chloride resin are preferable. These resins may be homopolymers or copolymers.

These resins can be used as the binding agent even in a non-magnetic layer and/or a back coating layer which will be described below. For the above binding agent, descriptions disclosed in paragraphs 0028 to 0031 of JP2010-24113A can be referred to. In addition, the binding agent may be a radiation curable resin such as an electron beam curable resin. For the radiation curable resin, descriptions disclosed in paragraphs 0044 and 0045 of JP2011-048878A can be referred to.

An average molecular weight of the resin used as the binding agent may be, for example, 10,000 or more and 200,000 or less as a weight-average molecular weight. The binding agent may be used in an amount of, for example, 1.0 to 30.0 parts by mass with respect to 100.0 parts by mass of the ferromagnetic powder.

Curing Agent

A curing agent can also be used together with the binding agent. As the curing agent, in an aspect, a thermosetting compound which is a compound in which a curing reaction (crosslinking reaction) is progressed due to heating can be used, and in another aspect, a photocurable compound in which a curing reaction (crosslinking reaction) is progressed due to light irradiation can be used. At least a part of the curing agent can be included in the magnetic layer in a state of being reacted (crosslinked) with other components such as the binding agent by progressing a curing reaction in a process of manufacturing the magnetic tape. The preferred curing agent is a thermosetting compound, and polyisocyanate is suitable for this. For details of the polyisocyanate, descriptions disclosed in paragraphs 0124 and 0125 of JP2011-216149A can be referred to. The curing agent can be used in a magnetic layer forming composition in an amount of, for example, 0 to 80.0 parts by mass, and preferably 50.0 to 80.0 parts by mass from the viewpoint of improving a strength of each layer such as the magnetic layer, with respect to 100.0 parts by mass of the binding agent.

Other Components

The magnetic layer may include one or more kinds of additives, as necessary. As the additive, a commercially available product can be appropriately selected and used according to a desired property. Alternatively, a compound synthesized by a well-known method can be used as the additive. Examples of the additive include the curing agent described above. In addition, examples of the additive which can be included in the magnetic layer include a non-magnetic filler, a lubricant, a dispersing agent, a dispersing assistant, an antibacterial agent, an antistatic agent, and an antioxidant. The non-magnetic filler has the same meaning as a non-magnetic particle or a non-magnetic powder. Examples of the non-magnetic filler include a non-magnetic filler capable of functioning as a protrusion forming agent and a non-magnetic filler capable of functioning as an abrasive. Further, as the additive, well-known additives such as various polymers disclosed in paragraphs 0030 to 0080 of JP2016-051493A can also be used.

As the protrusion forming agent which is an aspect of the non-magnetic filler, a particle of an inorganic substance can be used, a particle of an organic substance can be used, and a composite particle of an inorganic substance and an organic substance can also be used. In addition, carbon black can be used. Examples of the inorganic substance include an inorganic oxide such as metal oxide, metal carbonate, metal sulfate, metal nitride, metal carbide, and metal sulfide, and an inorganic oxide is preferable. In an aspect, the protrusion forming agent may be an inorganic oxide-based particle. Here, the term “-based” is used to mean “including”. An aspect of the inorganic oxide-based particle is a particle made of an inorganic oxide. Another aspect of the inorganic oxide-based particle is a composite particle of an inorganic oxide and an organic substance, and specific examples thereof include a composite particle of an inorganic oxide and a polymer. Examples of such particle include a particle in which a polymer bonded to a surface of an inorganic oxide particle.

An average particle size of the protrusion forming agent may be, for example, 30 to 300 nm, and is preferably 40 to 200 nm. In addition, the shape of the protrusion forming agent can be any shape. For example, in a case where the shape of the particle of the protrusion forming agent is a shape deviating from the true sphere, for example, a so-called deformed shape, it is supposed that the particle tends to be less affected by the change of the pressure because a large pushing resistance is likely to work in a case where a pressure is applied to the magnetic layer surface due to contact with the magnetic head. In addition, it is considered that even a particle having a non-uniform surface and a low surface smoothness tends to be less affected by the change of the pressure because a large pushing resistance is likely to work in a case where a pressure is applied. Therefore, in an aspect, it is preferable to use a protrusion forming agent in which the shape of the particle deviates from the true sphere and/or a protrusion forming agent in which the particle has the non-uniform surface and the low surface smoothness. In addition, in an aspect, a so-called amorphous shape can be used as the protrusion forming agent.

The abrasive, which is another aspect of the non-magnetic filler, is preferably a non-magnetic powder having a Mohs hardness of more than 8, and more preferably a non-magnetic powder having a Mohs hardness of 9 or more. On the other hand, a Mohs hardness of the protrusion forming agent may be, for example, 8 or less or 7 or less. The maximum value of a Mohs hardness is 10 for diamond. Specifically, as the abrasive, powders of alumina (for example, Al₂O₃), silicon carbide, boron carbide (for example, B₄C), SiO₂, TiC, chromium oxide (Cr₂O₃), cerium oxide, zirconium oxide (for example, ZrO₂), iron oxide, diamond, and the like can be used, and among these, alumina powder such as α-alumina and silicon carbide powder are preferable. In addition, the average particle size of the abrasive may be, for example, in a range of 30 to 300 nm, and preferably in a range of 50 to 200 nm.

From the viewpoint that the protrusion forming agent and the abrasive can exhibit their functions more satisfactorily, the content of the protrusion forming agent in the magnetic layer is preferably 0.1 to 5.0 parts by mass, more preferably 0.3 to 3.5 parts by mass, and still more preferably 0.5 to 2.5 parts by mass with respect to 100.0 parts by mass of the ferromagnetic powder. On the other hand, the content of the abrasive in the magnetic layer is preferably 1.0 to 20.0 parts by mass, more preferably 3.0 to 15.0 parts by mass, and still more preferably 4.0 to 10.0 parts by mass with respect to 100.0 parts by mass of the ferromagnetic powder.

As an example of the additive that may be used in the magnetic layer including the abrasive, a dispersing agent disclosed in paragraphs 0012 to 0022 of JP2013-131285A can be used as a dispersing agent for improving dispersibility of the abrasive in the magnetic layer forming composition. For the dispersing agent, descriptions disclosed in paragraphs 0061 and 0071 of JP2012-133837A can be referred to. The dispersing agent may be included in the non-magnetic layer. For the dispersing agent which may be included in the non-magnetic layer, a description disclosed in a paragraph 0061 of JP2012-133837A can be referred to.

As an aspect of the additive that may be included in the magnetic layer, a compound having an ammonium salt structure of an alkyl ester anion represented by Formula 1 can be exemplified.

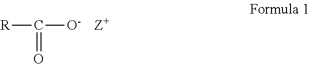

(In Formula 1, R represents an alkyl group having 7 or more carbon atoms or a fluorinated alkyl group having 7 or more carbon atoms, and Z⁺ represents an ammonium cation.)

The present inventor considers that the above compound can function as a lubricant. This point will be further described below.

The lubricant can be broadly divided into a fluid lubricant and a boundary lubricant. The present inventor considers that the compound having the ammonium salt structure of the alkyl ester anion represented by Formula 1 can function as a fluid lubricant. It is considered that the fluid lubricant itself can play a role of imparting lubricity to the magnetic layer by forming a liquid film on the magnetic layer surface. It is supposed that it is desirable that the fluid lubricant forms a liquid film on the magnetic layer surface, in order to control the friction characteristics of the magnetic tape. In addition, regarding the liquid film of the fluid lubricant, it is considered desirable to use an appropriate amount of the fluid lubricant forming the liquid film on the magnetic layer surface, from the viewpoint of enabling more stable sliding. In this regard, it is considered that the above compound containing the ammonium salt structure of the alkyl ester anion represented by Formula 1 can play an excellent role as the fluid lubricant even in a relatively small amount. Therefore, it is considered that the inclusion of the above compound in the magnetic layer leads to improvement of the sliding stability between the magnetic layer surface of the magnetic tape and the magnetic head.

Hereinafter, the above compound will be described in more detail.

In the present invention and the present specification, unless otherwise noted, groups described below may have a substituent or may be unsubstituted. In addition, for a group having a substituent, the term “carbon atoms” means the number of carbon atoms not including the number of carbon atoms of the substituent, unless otherwise noted. In the present invention and the present specification, examples of the substituent include an alkyl group (for example, an alkyl group having 1 to 6 carbon atoms), a hydroxy group, an alkoxy group (for example, an alkoxy group having 1 to 6 carbon atoms), a halogen atom (for example, a fluorine atom, a chlorine atom, a bromine atom, or the like), a cyano group, an amino group, a nitro group, an acyl group, a carboxy group, a salt of a carboxy group, a sulfonic acid group, and a salt of a sulfonic acid group.

In the compound having the ammonium salt structure of the alkyl ester anion represented by Formula 1, at least a part included in the magnetic layer can form a liquid film on the magnetic layer surface, and a part included in the magnetic layer can move to the magnetic layer surface during sliding with the magnetic head to form a liquid film. In addition, a part of the compound can be included in the non-magnetic layer described below, and can move to the magnetic layer and further move to the magnetic layer surface to form a liquid film. The “alkyl ester anion” can also be called an “alkyl carboxylate anion”.

In Formula 1, R represents an alkyl group having 7 or more carbon atoms or a fluorinated alkyl group having 7 or more carbon atoms. The fluorinated alkyl group has a structure in which some or all of the hydrogen atoms constituting the alkyl group are substituted with fluorine atoms. The alkyl group or the fluorinated alkyl group represented by R may have a linear structure or a branched structure, may be a cyclic alkyl group or a fluorinated alkyl group, and is preferably a linear structure. The alkyl group or the fluorinated alkyl group represented by R may have a substituent, may be unsubstituted, and is preferably unsubstituted. The alkyl group represented by R can be represented by, for example. CₙH₂ₙ₊₁₋. Here, n represents an integer of 7 or more. In addition, the fluorinated alkyl group represented by R may have a structure in which some or all of the hydrogen atoms constituting the alkyl group represented by, for example, CₙH₂ₙ₊₁₋ are substituted with fluorine atoms. The carbon number of the alkyl group or the fluorinated alkyl group represented by R is 7 or more, preferably 8 or more, more preferably 9 or more, still more preferably 10 or more, still more preferably 11 or more, still more preferably 12 or more, and still more preferably 13 or more. In addition, the carbon number of the alkyl group or the fluorinated alkyl group represented by R is preferably 20 or less, more preferably 19 or less, and still more preferably 18 or less.

In Formula 1, Z⁺ represents an ammonium cation. Specifically, the ammonium cation has the following structure. In the present invention and the present specification, “*” in the formula representing a part of a compound represents a bonding position between a structure of the part and an adjacent atom.

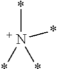

A nitrogen cation N⁺ of the ammonium cation and an oxygen anion O⁻ in Formula 1 may form a salt crosslinking group to form the ammonium salt structure of the alkyl ester anion represented by Formula 1. The inclusion of the compound having the ammonium salt structure of the alkyl ester anion represented by Formula 1 in the magnetic layer can be confirmed by analyzing the magnetic tape by X-ray photoelectron spectroscopy (electron spectroscopy for chemical analysis (ESCA)), infrared spectroscopy (IR), or the like.

In an aspect, the ammonium cation represented by Z⁺ may be provided, for example, by a nitrogen atom of a nitrogen-containing polymer becoming a cation. The nitrogen-containing polymer means a polymer including a nitrogen atom. In the present invention and the present specification, the term “polymer” is used to encompass a homopolymer and a copolymer. The nitrogen atom may be included as an atom constituting a main chain of the polymer in an aspect, and may be included as an atom constituting a side chain of the polymer in an aspect.

As an aspect of the nitrogen-containing polymer, polyalkyleneimine can be exemplified. Polyalkyleneimine is a ring-opening polymer of alkyleneimine and is a polymer having a plurality of repeating units represented by Formula 2.

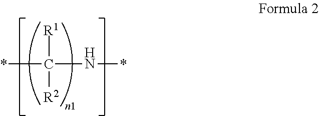

A nitrogen atom N constituting a main chain in Formula 2 is a nitrogen cation N⁺ to provide the ammonium cation represented by Z⁺ in Formula 1. Then, the ammonium salt structure can be formed with the alkyl ester anion, for example, as follows.

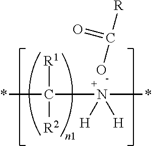

Hereinafter, Formula 2 will be described in more detail.

In Formula 2, R¹ and R² each independently represent a hydrogen atom or an alkyl group, and n1 represents an integer of 2 or more.

Examples of the alkyl group represented by R¹ or R² include an alkyl group having 1 to 6 carbon atoms, preferably an alkyl group having 1 to 3 carbon atoms, more preferably a methyl group or an ethyl group, and still more preferably a methyl group. The alkyl group represented by R¹ or R² is preferably an unsubstituted alkyl group. The combination of R¹ and R² in Formula 2 may be a form in which one is a hydrogen atom and the other is an alkyl group, a form in which both are hydrogen atoms, and a form in which both are alkyl groups (the same or different alkyl groups), and the form in which both are hydrogen atoms is preferable. As the alkyleneimine that provides the polyalkyleneimine, a structure having the lowest number of carbon atoms constituting a ring is ethyleneimine, and the number of carbon atoms in a main chain of the alkyleneimine (ethyleneimine) obtained by the ring opening of the ethyleneimine is 2. Therefore, n1 in Formula 2 is 2 or more. n1 in Formula 2 may be, for example, 10 or less, 8 or less, 6 or less, or 4 or less. The polyalkyleneimine may be a homopolymer including only the same structure as the repeating structure represented by Formula 2, or may be a copolymer including two or more different structures as the repeating structure represented by Formula 2. A number-average molecular weight of polyalkyleneimine that can be used to form the compound having the ammonium salt structure of the alkyl ester anion represented by Formula 1 may be, for example, 200 or more, preferably 300 or more, and more preferably 400 or more. The number-average molecular weight of the polyalkyleneimine may be, for example, 10,000 or less, preferably 5,000 or less, and more preferably 2,000 or less.

In the present invention and the present specification, the average molecular weight (weight-average molecular weight and number-average molecular weight) means a value measured by gel permeation chromatography (GPC) with standard polystyrene conversion. Unless otherwise noted, the average molecular weight shown in Examples described below is a value (polystyrene conversion value) obtained by standard polystyrene conversion of values measured under the following measurement conditions using GPC.
GPC device: HLC-8220 (manufactured by Tosoh Corporation)
Guard column: TSKguardcolumn Super HZM-H
Column: TSKgel Super HZ 2000, TSKgel Super HZ 4000, TSKgel Super HZ-M (manufactured by Tosoh Corporation, 4.6 mm (inner diameter)×15.0 cm, three columns connected in series)
Eluent: Tetrahydrofuran (THF), containing stabilizer (2,6-di-t-butyl-4-methylphenol)
Flow rate of eluent: 0.35 mL/min
Column temperature: 40° C.
Inlet temperature: 40° C.
Refractive index (RI) measurement temperature: 40° C.
Sample concentration: 0.3 mass %
Sample injection amount: 10 μL

As another aspect of the nitrogen-containing polymer, polyallylamine can be exemplified. Polyallylamine is a polymer of allylamine and is a polymer having a plurality of repeating units represented by Formula 3.

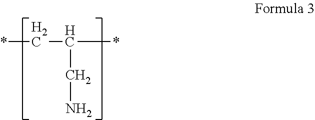

A nitrogen atom N constituting an amino group of a side chain in Formula 3 is a nitrogen cation N⁺ to provide the ammonium cation represented by Z⁺ in Formula 1. Then, the ammonium salt structure can be formed with the alkyl ester anion, for example, as follows.

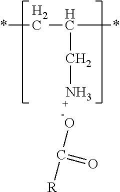

A weight-average molecular weight of polyallylamine that can be used to form the compound having the ammonium salt structure of the alkyl ester anion represented by Formula 1 may be, for example, 200 or more, preferably 1,000 or more, and more preferably 1,500 or more. The weight-average molecular weight of the polyallylamine may be, for example, 15,000 or less, preferably 10,000 or less, and more preferably 8,000 or less.

The inclusion of a compound having a structure derived from polyalkyleneimine or polyallylamine as the compound having the ammonium salt structure of the alkyl ester anion represented by Formula 1 can be confirmed by analyzing the magnetic layer surface by time-of-flight secondary ion mass spectrometry (TOF-SIMS) or the like.

The compound having the ammonium salt structure of the alkyl ester anion represented by Formula 1 may be a salt of the nitrogen-containing polymer and one or more kinds of fatty acids selected from the group consisting of fatty acids having 7 or more carbon atoms and fluorinated fatty acids having 7 or more carbon atoms. The nitrogen-containing polymer forming a salt may be one or more kinds of nitrogen-containing polymers, and may be, for example, a nitrogen-containing polymer selected from the group consisting of polyalkyleneimine and polyallylamine. The fatty acids forming a salt may be one or more kinds of fatty acids selected from the group consisting of fatty acids having 7 or more carbon atoms and fluorinated fatty acids having 7 or more carbon atoms. The fluorinated fatty acid has a structure in which some or all of the hydrogen atoms constituting an alkyl group bonded to a carboxy group COOH in the fatty acid are substituted with fluorine atoms. For example, the salt forming reaction can easily proceed by mixing the nitrogen-containing polymer and the above fatty acids at a room temperature. A room temperature is, for example, about 20° C. to 25° C. In an aspect, one or more kinds of nitrogen-containing polymers and one or more kinds of fatty acids are used as components of the magnetic layer forming composition, and these are mixed in a process of preparing the magnetic layer forming composition to allow the salt forming reaction to proceed. In addition, in an aspect, the magnetic layer forming composition can be prepared by mixing one or more kinds of nitrogen-containing polymers and one or more kinds of fatty acids to form a salt before preparation of the magnetic layer forming composition, and then using the salt as a component of the magnetic layer forming composition. This point also applies to a case of forming a non-magnetic layer including the compound having the ammonium salt structure of the alkyl ester anion represented by Formula 1. For example, for the magnetic layer, 0.1 to 10.0 parts by mass of the nitrogen-containing polymer can be used, and 0.5 to 8.0 parts by mass of the nitrogen-containing polymer is preferably used, per 100.0 parts by mass of the ferromagnetic powder. The above fatty acids can be used, for example, in an amount of 0.05 to 10.0 parts by mass and are preferably used in an amount of 0.1 to 5.0 parts by mass, per 100.0 parts by mass of the ferromagnetic powder. In addition, in a case of preparing the magnetic layer forming composition, the protrusion forming agent can be separately dispersed from the ferromagnetic powder, and can also be separately dispersed from the abrasive. In such a separate dispersion, the protrusion-forming agent can be mixed with one or more kinds of nitrogen-containing polymers and one or more kinds of fatty acids to efficiently adsorb the compound having the ammonium salt structure of the alkyl ester anion represented by Formula 1 to the protrusion forming agent. For example, 0.01 to 1.0 part by mass of nitrogen-containing polymer can be mixed per 1.0 part by mass of the protrusion forming agent, and 0.01 to 1.0 part by mass of fatty acids can be mixed. In addition, in an aspect, after one or more kinds of nitrogen-containing polymers and one or more kinds of fatty acids are mixed to form a salt, this salt can be mixed with the protrusion forming agent in the above-described separate dispersion. For example, such a salt can be mixed in an amount of 0.03 to 3.0 parts by mass per 1.0 part by mass of the protrusion forming agent. The present inventor considers that separately dispersing the protrusion forming agent together with the above components is preferable in controlling the rate of change (μ1/μ2) in friction coefficient before and after storage of the magnetic tape, to 0.7 or more. Specifically, the present inventor considers that by separately dispersing the protrusion forming agent together with the above components, the protrusion forming agent can be coated with the above salt, whereby a component that can function as a lubricant such as the above salt can be easily supplied from the inside of the magnetic layer to the surface in an early stage. The present inventor supposes that this contributes to making it possible to bring the friction coefficient increased by repeated running closer to the value before the increase in a short period of time. In addition, for the non-magnetic layer, for example, 0.1 to 10.0 parts by mass of the nitrogen-containing polymer can be used, and 0.5 to 8.0 parts by mass of the nitrogen-containing polymer is preferably used, per 100.0 parts by mass of the non-magnetic powder. The above fatty acids can be used, for example, in an amount of 0.05 to 10.0 parts by mass and are preferably used in an amount of 0.1 to 5.0 parts by mass, per 100.0 parts by mass of the non-magnetic powder. In a case where the nitrogen-containing polymer and the fatty acids are mixed to form an ammonium salt of the alkyl ester anion represented by Formula 1, a nitrogen atom constituting the nitrogen-containing polymer may react with a carboxy group of the fatty acids to form the following structure, and a form including such a structure is also included in the compound.

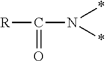

Examples of the fatty acids include fatty acids having an alkyl group described above as R in Formula 1 and fluorinated fatty acids having a fluorinated alkyl group described above as R in Formula 1.

A mixing ratio of the nitrogen-containing polymer used to form the compound having the ammonium salt structure of the alkyl ester anion represented by Formula 1 to the fatty acid is preferably 10:90 to 90:10, more preferably 20:80 to 85:15, and still more preferably 30:70 to 80:20 as a mass ratio of the nitrogen-containing polymer:the fatty acids. In addition, the compound having the ammonium salt structure of the alkyl ester anion represented by Formula 1 is preferably included in the magnetic layer in an amount of 0.01 parts by mass or more, more preferably 0.1 parts by mass or more, and still more preferably 0.5 parts by mass or more with respect to 100.0 parts by mass of the ferromagnetic powder. Here, the content of the compound in the magnetic layer means the total amount of the amount of the liquid film formed on the magnetic layer surface and the amount included inside the magnetic layer. On the other hand, a high content of the ferromagnetic powder in the magnetic layer is preferable from the viewpoint of high-density recording. Therefore, from the viewpoint of high-density recording, it is preferable that the content of components other than the ferromagnetic powder is small. From this viewpoint, the content of the compound in the magnetic layer is preferably 15.0 parts by mass or less, more preferably 10.0 parts by mass or less, and still more preferably 8.0 parts by mass or less with respect to 100.0 parts by mass of the ferromagnetic powder. In addition, the preferred range of the content of the compound in the magnetic layer forming composition used for forming the magnetic layer is also the same.

The magnetic layer may include one or more additional components that can function as a lubricant. Examples of the component that can function as a lubricant include fatty acid ester and fatty acid amide. Examples of the fatty acid ester include esters of lauric acid, myristic acid, palmitic acid, stearic acid, oleic acid, linoleic acid, linolenic acid, behenic acid, erucic acid, and elaidic acid. Specific examples thereof include butyl myristate, butyl palmitate, butyl stearate, neopentyl glycol dioleate, sorbitan monostearate, sorbitan distearate, sorbitan tristearate, oleyl oleate, isocetyl stearate, isotridecyl stearate, octyl stearate, isooctyl stearate, amyl stearate, and butoxyethyl stearate. A content of the fatty acid ester in the magnetic layer forming composition or the magnetic layer is, for example, 0.1 to 10.0 parts by mass, and preferably 1.0 to 7.0 parts by mass per 100.0 parts by mass of the ferromagnetic powder. Examples of the fatty acid amide include amides of various fatty acids such as lauric acid, myristic acid, palmitic acid, stearic acid, oleic acid, linoleic acid, linolenic acid, behenic acid, erucic acid, and elaidic acid, and specifically, lauric acid amide, myristic acid amide, palmitic acid amide, and stearic acid amide. A content of the fatty acid amide in the magnetic layer is, for example, 0 to 3.0 parts by mass, preferably 0 to 2.0 parts by mass, and more preferably 0 to 1.0 part by mass per 100.0 parts by mass of the ferromagnetic powder. In addition, the non-magnetic layer may also include one or more components that can function as a lubricant. For example, the non-magnetic layer may include one or more components selected from the group consisting of fatty acids, fatty acid esters, and fatty acid amides. A content of the fatty acid in a non-magnetic layer forming composition or the non-magnetic layer is, for example, 0 to 10.0 parts by mass, preferably 1.0 to 10.0 parts by mass, and more preferably 1.0 to 7.0 parts by mass per 100.0 parts by mass of the non-magnetic powder. A content of the fatty acid ester in the non-magnetic layer forming composition or the magnetic layer is, for example, 0 to 10.0 parts by mass, and preferably 0.1 to 8.0 parts by mass per 100.0 parts by mass of the non-magnetic powder. A content of the fatty acid amide in the non-magnetic layer forming composition or the non-magnetic layer is, for example, 0 to 3.0 parts by mass, and preferably 0 to 1.0 part by mass per 100.0 parts by mass of the non-magnetic powder. For the dispersing agent, descriptions disclosed in paragraphs 0061 and 0071 of JP2012-133837A can be referred to. The dispersing agent may be added to the non-magnetic layer forming composition. For the dispersing agent that can be added to the non-magnetic layer forming composition, a description disclosed in a paragraph 0061 of JP2012-133837A can be referred to.

Non-Magnetic Layer

Next, the non-magnetic layer will be described. The above magnetic tape may have a magnetic layer directly on the non-magnetic support, or may have a non-magnetic layer including a non-magnetic powder between the non-magnetic support and the magnetic layer. The non-magnetic powder used for the non-magnetic layer may be an inorganic substance powder (inorganic powder) or an organic substance powder (organic powder). In addition, carbon black and the like can be used. Examples of the inorganic substance include metal, metal oxide, metal carbonate, metal sulfate, metal nitride, metal carbide, and metal sulfide. The non-magnetic powder can be purchased as a commercially available product or can be manufactured by a well-known method. For details thereof, descriptions disclosed in paragraphs 0146 to 0150 of JP2011-216149A can be referred to. For carbon black which can be used in the non-magnetic layer, descriptions disclosed in paragraphs 0040 and 0041 of JP2010-24113A can be referred to. The content (filling percentage) of the non-magnetic powder of the non-magnetic layer is preferably in a range of 50 to 90 mass % and more preferably in a range of 60 to 90 mass %.

The non-magnetic layer can include a binding agent, and can also include an additive. For other details of the binding agent or the additive of the non-magnetic layer, a well-known technology regarding the non-magnetic layer can be applied. In addition, in regards to the type and the content of the binding agent, and the type and the content of the additive, for example, a well-known technology regarding the magnetic layer can be applied.

The non-magnetic layer of the magnetic tape also includes a substantially non-magnetic layer including a small amount of ferromagnetic powder as impurities, for example, or intentionally, together with the non-magnetic powder. Here, the substantially non-magnetic layer refers to a layer having a residual magnetic flux density of 10 mT or less, a coercivity of 7.96 kA/m (100 Oe) or less, or a residual magnetic flux density of 10 mT or less and a coercivity of 7.96 kA/m (100 Oe) or less. It is preferable that the non-magnetic layer does not have a residual magnetic flux density and a coercivity.

Non-Magnetic Support

Next, the non-magnetic support will be described. Examples of the non-magnetic support (hereinafter, simply referred to as a “support”) include well-known components such as polyethylene terephthalate, polyethylene naphthalate, polyamide, polyamideimide, and aromatic polyamide subjected to biaxial stretching. Among these, polyethylene terephthalate, polyethylene naphthalate, and polyamide are preferable. These supports may be subjected to a corona discharge, a plasma treatment, an easy-bonding treatment, or a heat treatment in advance.

Back Coating Layer

The tape may or may not have a back coating layer including a non-magnetic powder on a surface side of the non-magnetic support opposite to a surface side having the magnetic layer. The back coating layer preferably contains one or both of carbon black and an inorganic powder. The back coating layer can include a binding agent, and can also include an additive. For details of the non-magnetic powder, the binding agent, and the additive of the back coating layer, a well-known technology regarding the back coating layer can be applied, and a well-known technology regarding the magnetic layer and/or the non-magnetic layer can be applied. For example, for the back coating layer, descriptions disclosed in paragraphs 0018 to 0020 of JP2006-331625A and column 4, line 65 to column 5, line 38 of U.S. Pat. No. 7,029,774B can be referred to.

Various Thicknesses

Regarding a thickness (total thickness) of the magnetic tape, it has been required to increase the recording capacity (increase the capacity) of the magnetic tape with the enormous increase in the amount of information in recent years. For example, as means for increasing the capacity, a thickness of the magnetic tape may be reduced to increase a length of the magnetic tape accommodated in one roll of a magnetic tape cartridge. From this point, the thickness (total thickness) of the magnetic tape is preferably 5.6 μm or less, more preferably 5.5 μm or less, still more preferably 5.4 μm or less, still more preferably 5.3 μm or less, and still more preferably 5.2 μm or less. In addition, from the viewpoint of ease of handling, the thickness of the magnetic tape is preferably 3.0 μm or more, and more preferably 3.5 μm or more.

The thickness (total thickness) of the magnetic tape can be measured by the following method.

Ten tape samples (for example, 5 to 10 cm in length) are cut out from any part of the magnetic tape, and these tape samples are stacked to measure the thickness. A value (thickness per tape sample) obtained by dividing the measured thickness by 1/10 is defined as the tape thickness. The thickness measurement can be performed using a well-known measuring device capable of measuring the thickness on the order of 0.1 μm.

A thickness of the non-magnetic support is preferably 3.0 to 5.0 μm.

A thickness of the magnetic layer can be optimized according to a saturation magnetization amount, a head gap length, and a band of a recording signal of the used magnetic head, and is generally 0.01 μm to 0.15 μm, and from the viewpoint of high-density recording, is preferably 0.02 μm to 0.12 μm, and more preferably 0.03 μm to 0.1 μm. The magnetic layer need only be at least a single layer, the magnetic layer may be separated into two or more layers having different magnetic properties, and a configuration of a well-known multilayered magnetic layer can be applied as the magnetic layer. A thickness of the magnetic layer in a case where the magnetic layer is separated into two or more layers is a total thickness of the layers.

A thickness of the non-magnetic layer is, for example, 0.1 to 1.5 μm, and preferably 0.1 to 1.0 μm.

A thickness of the back coating layer is preferably 0.9 μm or less, and more preferably 0.1 to 0.7 μm.

Various thicknesses such as the thickness of the magnetic layer can be obtained by, for example, the following method.

A cross section of the magnetic tape in a thickness direction is exposed by an ion beam, and then observation on the exposed cross section is performed using a scanning electron microscope or a transmission electron microscope. Various thicknesses can be obtained as an arithmetic average of thicknesses obtained at two optional points in the cross section observation. Alternatively, the various thicknesses can be obtained as a designed thickness calculated according to manufacturing conditions.

Manufacturing Method

Preparation of Each Layer Forming Composition

A composition for forming the magnetic layer, the non-magnetic layer, or the back coating layer usually includes a solvent together with the various components described above. As a solvent, various organic solvents generally used for manufacturing a coating type magnetic recording medium can be used. Among these, from the viewpoint of solubility of the binding agent usually used in the coating type magnetic recording medium, each layer forming composition preferably includes one or more ketone solvents such as acetone, methyl ethyl ketone, methyl isobutyl ketone, diisobutyl ketone, cyclohexanone, isophorone, and tetrahydrofuran. The amount of the solvent in each layer forming composition is not particularly limited, and can be set to the same as that of each layer forming composition of a typical coating type magnetic recording medium. In addition, a process of preparing each layer forming composition can generally include at least a kneading process, a dispersing process, and a mixing process provided before and after these processes as necessary. Each process may be divided into two or more stages. Components used for the preparation of each layer forming composition may be added at an initial stage or in a middle stage of each process. Each component may be separately added in two or more processes. For example, a binding agent may be added separately in a kneading process, a dispersing process, and a mixing process for adjusting a viscosity after dispersion. In addition, as described above, one or more kinds of nitrogen-containing polymers and one or more kinds of the fatty acids are used as the components of the magnetic layer forming composition, and these are mixed in a process of preparing the magnetic layer forming composition to allow the salt forming reaction to proceed. In addition, in an aspect, the magnetic layer forming composition can be prepared by mixing one or more kinds of nitrogen-containing polymers and one or more kinds of fatty acids to form a salt before preparation of the magnetic layer forming composition, and then using the salt as a component of the magnetic layer forming composition. This point also applies to a process of preparing the non-magnetic layer forming composition. In an aspect, in a process of preparing the magnetic layer forming composition, after a dispersion liquid including a protrusion forming agent (hereinafter, referred to as a “protrusion forming agent liquid”) is prepared, the protrusion forming agent liquid can be mixed with one or more other components of the magnetic layer forming composition. For example, the protrusion forming agent liquid can be prepared by a well-known dispersion treatment such as an ultrasonic treatment. The ultrasonic treatment can be performed for about 1 to 300 minutes at an ultrasonic output of about 10 to 2000 watts per 200 cc (1 cc=1 cm³), for example. In a case where the protrusion forming agent is separately dispersed (that is, in a case where the protrusion forming agent liquid is prepared), the above-described components can be mixed. In addition, the filtering may be performed after the dispersion treatment. For the filter used for the filtering, the following description can be referred to.

In a process of manufacturing the magnetic tape, a well-known manufacturing technology in a related art can be used in a part or all of the processes. In the kneading process, an open kneader, a continuous kneader, a pressure kneader, or a kneader having a strong kneading force such as an extruder is preferably used. Details of the kneading treatment are described in JP1989-106338A (JP-H01-106338A) and JP1989-79274A (JP-H01-79274A). In addition, in order to disperse each layer forming composition, glass beads and/or other beads can be used. As such dispersion beads, zirconia beads, titania beads, and steel beads which are dispersion beads having a high specific gravity are suitable. These dispersion beads are preferably used by optimizing a particle diameter (bead diameter) and filling percentage. As a dispersing device, a well-known dispersing device can be used. Each layer forming composition may be filtered by a well-known method before being subjected to a coating process. The filtering can be performed by using a filter, for example. As the filter used in the filtering, a filter having a pore diameter of 0.01 to 3 μm (for example, filter made of glass fiber or filter made of polypropylene) can be used, for example.

Coating Process

The magnetic layer can be formed, for example, by directly applying the magnetic layer forming composition onto the non-magnetic support or performing multilayer applying of the magnetic layer forming composition with the non-magnetic layer forming composition in order or at the same time. In a case of performing an alignment treatment, the alignment treatment is performed on a coating layer of the magnetic layer forming composition in an alignment zone while the coating layer is in a wet state. For the alignment treatment, the various well-known technologies including a description disclosed in a paragraph 0052 of JP2010-24113A can be used. For example, a vertical alignment treatment can be performed by a well-known method such as a method using a polar opposing magnet. In the alignment zone, a drying speed of the coating layer can be controlled depending on a temperature of dry air and an air volume and/or a transportation speed in the alignment zone. Further, the coating layer may be preliminarily dried before the transportation to the alignment zone.

The back coating layer can be formed by applying the back coating layer forming composition onto a side of the non-magnetic support opposite to a side having the magnetic layer (or to be provided with the magnetic layer). For details of coating for forming each layer, a description disclosed in a paragraph 0066 of JP2010-231843A can be referred to.

Other Processes After the above-described coating process is performed, a calendering treatment can be performed to improve the surface smoothness of the magnetic tape. For calendering conditions, a calender pressure is, for example, 200 to 500 kN/m, preferably 250 to 350 kN/m, a calender temperature is, for example, 70° C. to 120° C., preferably 80° C. to 100° C., and a calender speed is, for example, 50 to 300 m/min, preferably 80 to 200 m/min. Further, the harder a roll having a hard surface is used as a calender roll, and the larger the number of stages is, the smoother the magnetic layer surface tends to be.

For other various processes for manufacturing the magnetic tape, descriptions disclosed in paragraphs 0067 to 0070 of JP 2010-231843A can be referred to.

Through various processes, a long magnetic tape original roll can be obtained. The obtained magnetic tape original roll is cut (slit) by a well-known cutter to have a width of the magnetic tape to be accommodated in the magnetic tape cartridge. The width can be determined according to the standard, and is usually ½ inches. ½ inches=12.65 mm.

A servo pattern is usually formed on the magnetic tape obtained by slitting.

Formation of Servo Pattern

The term “formation of servo pattern” can also be referred to as “recording of servo signal”. Hereinafter, the formation of the servo pattern will be described.

The servo pattern is usually formed along the longitudinal direction of the magnetic tape. Examples of control (servo control) systems using a servo signal include a timing-based servo (TBS), an amplitude servo, and a frequency servo.

As shown in a European computer manufacturers association (ECMA)-319 (June 2001), a magnetic tape (generally called “LTO tape”) conforming to a linear tape-open (LTO) standard employs a timing-based servo system. In this timing-based servo system, the servo pattern is formed by continuously disposing a plurality of pairs of non-parallel magnetic stripes (also referred to as “servo stripes”) in the longitudinal direction of the magnetic tape. In the present invention and the present specification, the term “timing-based servo pattern” refers to a servo pattern that enables head tracking in a timing-based servo system. As described above, the reason why the servo pattern is formed of a pair of non-parallel magnetic stripes is to indicate, to a servo signal reading element passing over the servo pattern, a passing position thereof. Specifically, the pair of magnetic stripes is formed such that an interval thereof continuously changes along a width direction of the magnetic tape, and the servo signal reading element reads the interval to thereby sense a relative position between the servo pattern and the servo signal reading element. Information on this relative position enables tracking on a data track. Therefore, a plurality of servo tracks are usually set on the servo pattern along a width direction of the magnetic tape.

A servo band is formed of a servo pattern continuous in the longitudinal direction of the magnetic tape. A plurality of the servo bands are usually provided on the magnetic tape. For example, in an LTO tape, the number of the servo bands is five. Regions interposed between two adjacent servo bands are data bands. The data band is formed of a plurality of data tracks, and each data track corresponds to each servo track.

Further, in an aspect, as shown in JP2004-318983A, information indicating a servo band number (referred to as “servo band identification (ID)” or “unique data band identification method (UDIM) information”) is embedded in each servo band. This servo band ID is recorded by shifting a specific one of the plurality of pairs of the servo stripes in the servo band so that positions thereof are relatively displaced in the longitudinal direction of the magnetic tape. Specifically, a way of shifting the specific one of the plurality of pairs of servo stripes is changed for each servo band. Accordingly, the recorded servo band ID is unique for each servo band, and thus, the servo band can be uniquely specified only by reading one servo band with a servo signal reading element.

As a method for uniquely specifying the servo band, there is a method using a staggered method as shown in ECMA-319 (June 2001). In this staggered method, a group of pairs of non-parallel magnetic stripes (servo stripes) disposed continuously in plural in the longitudinal direction of the magnetic tape is recorded so as to be shifted in the longitudinal direction of the magnetic tape for each servo band. Since this combination of shifting methods between adjacent servo bands is unique throughout the magnetic tape, it is possible to uniquely specify a servo band in a case of reading a servo pattern with two servo signal reading elements.

As shown in ECMA-319 (June 2001), information indicating a position of the magnetic tape in the longitudinal direction (also referred to as “longitudinal position (LPOS) information”) is usually embedded in each servo band. This LPOS information is also recorded by shifting the positions of the pair of servo stripes in the longitudinal direction of the magnetic tape, as the UDIM information. Here, unlike the UDIM information, in this LPOS information, the same signal is recorded in each servo band.

It is also possible to embed, in the servo band, the other information different from the above UDIM information and LPOS information. In this case, the embedded information may be different for each servo band as the UDIM information or may be common to all servo bands as the LPOS information.

As a method of embedding information in the servo band, it is possible to employ a method other than the above. For example, a predetermined code may be recorded by thinning out a predetermined pair from the group of pairs of servo stripes.

A head for forming a servo pattern is called a servo write head. The servo write head usually has a pair of gaps corresponding to the pair of magnetic stripes as many as the number of servo bands. Usually, a core and a coil are connected to each pair of gaps, and by supplying a current pulse to the coil, a magnetic field generated in the core can cause generation of a leakage magnetic field in the pair of gaps. In a case of forming the servo pattern, by inputting a current pulse while running the magnetic tape on the servo write head, the magnetic pattern corresponding to the pair of gaps is transferred to the magnetic tape to form the servo pattern. A width of each gap can be appropriately set according to a density of the servo pattern to be formed. The width of each gap can be set to, for example, 1 μm or less, 1 to 10 μm, 10 μm or more, and the like.

Before the servo pattern is formed on the magnetic tape, the magnetic tape is usually subjected to a demagnetization (erasing) treatment. This erasing treatment can be performed by applying a uniform magnetic field to the magnetic tape using a direct current magnet or an alternating current magnet. The erasing treatment includes direct current (DC) erasing and alternating current (AC) erasing. AC erasing is performed by gradually decreasing an intensity of the magnetic field while reversing a direction of the magnetic field applied to the magnetic tape. On the other hand, DC erasing is performed by applying a unidirectional magnetic field to the magnetic tape. As the DC erasing, there are two methods. A first method is horizontal DC erasing of applying a unidirectional magnetic field along a longitudinal direction of the magnetic tape. A second method is vertical DC erasing of applying a unidirectional magnetic field along a thickness direction of the magnetic tape. The erasing treatment may be performed on the entire magnetic tape or may be performed for each servo band of the magnetic tape.

A direction of the magnetic field of the servo pattern to be formed is determined according to a direction of the erasing. For example, in a case where the horizontal DC erasing is performed to the magnetic tape, the servo pattern is formed so that the direction of the magnetic field is opposite to the direction of the erasing. Therefore, an output of a servo signal obtained by reading the servo pattern can be increased. As shown in JP2012-53940A, in a case where a magnetic pattern is transferred to, using the gap, a magnetic tape that has been subjected to vertical DC erasing, a servo signal obtained by reading the formed servo pattern has a monopolar pulse shape. On the other hand, in a case where a magnetic pattern is transferred to, using the gap, a magnetic tape that has been subjected to horizontal DC erasing, a servo signal obtained by reading the formed servo pattern has a bipolar pulse shape.

Magnetic Tape Cartridge

Another aspect of the present invention relates to a magnetic tape cartridge including the magnetic tape described above.

The details of the magnetic tape included in the above magnetic tape cartridge are as described above.

In the magnetic tape cartridge, generally, the magnetic tape is accommodated inside a cartridge body in a state of being wound around a reel. The reel is rotatably provided inside the cartridge body. As the magnetic tape cartridge, a single reel type magnetic tape cartridge having one reel inside the cartridge body and a dual reel type magnetic tape cartridge having two reels inside the cartridge body are widely used. In a case where the single reel type magnetic tape cartridge is mounted on a magnetic tape apparatus for recording and/or reproducing data on the magnetic tape, the magnetic tape is pulled out of the magnetic tape cartridge to be wound around the reel on the magnetic tape apparatus side. A magnetic head is disposed on a magnetic tape transportation path from the magnetic tape cartridge to a winding reel. Feeding and winding of the magnetic tape are performed between a reel (supply reel) on the magnetic tape cartridge side and a reel (winding reel) on the magnetic tape apparatus side. During this time, data is recorded and/or reproduced as the magnetic head and the magnetic layer surface of the magnetic tape come into contact with each other to be slid on each other. With respect to this, in the dual reel type magnetic tape cartridge, both reels of the supply reel and the winding reel are provided in the magnetic tape cartridge.

The magnetic tape cartridge may include a cartridge memory in an aspect. The cartridge memory may be, for example, a non-volatile memory, and may be a memory in which tension adjustment information has already been recorded or a memory in which tension adjustment information is recorded. The tension adjustment information is information for adjusting the tension applied in the longitudinal direction of the magnetic tape. Regarding the cartridge memory, the description below can also be referred to.

The magnetic tape and the magnetic tape cartridge can be suitably used in the magnetic tape apparatus (in other words, a magnetic recording and reproducing system) that controls the dimension in the width direction of the magnetic tape by adjusting the tension applied in the longitudinal direction of the magnetic tape.

Magnetic Tape Apparatus

Still another aspect of the present invention relates to a magnetic tape apparatus including the magnetic tape described above. In the magnetic tape apparatus, recording of data on the magnetic tape and/or reproduction of data recorded on the magnetic tape can be performed as the magnetic layer surface of the magnetic tape and the magnetic head come into contact with each other to be slid on each other. The magnetic tape apparatus can attachably and detachably include the magnetic tape cartridge according to an aspect of the present invention.

The magnetic tape cartridge can be mounted on the magnetic tape apparatus comprising the magnetic head and used for recording and/or reproducing data. In the present invention and the present specification, the term “magnetic tape apparatus” means an apparatus capable of performing at least one of the recording of data on the magnetic tape or the reproduction of data recorded on the magnetic tape. Such an apparatus is generally called a drive. The magnetic head included in the magnetic tape apparatus can be a recording head capable of performing the recording of data on the magnetic tape, or can be a reproducing head capable of performing the reproduction of data recorded on the magnetic tape. In addition, in an aspect, the magnetic tape apparatus can include both a recording head and a reproducing head as separate magnetic heads. In another aspect, the magnetic head included in the magnetic tape apparatus may have a configuration in which both a recording element and a reproducing element are provided in one magnetic head. As the reproducing head, a magnetic head (MR head) including a magnetoresistive (MR) element capable of sensitively reading information recorded on the magnetic tape as a reproducing element is preferable. As the MR head, various well-known MR heads (for example, a giant magnetoresistive (GMR) head and a tunnel magnetoresistive (TMR) head) can be used. In addition, the magnetic head which performs the recording of data and/or the reproduction of data may include a servo signal reading element. Alternatively, as a head other than the magnetic head which performs the recording of data and/or the reproduction of data, a magnetic head (servo head) comprising a servo signal reading element may be included in the magnetic tape apparatus. For example, a magnetic head that records data and/or reproduces recorded data (hereinafter also referred to as “recording and reproducing head”) can include two servo signal reading elements, and the two servo signal reading elements can simultaneously read two adjacent servo bands with the data band interposed therebetween. One or a plurality of elements for data can be disposed between the two servo signal reading elements. An element for recording data (recording element) and an element for reproducing data (reproducing element) are collectively referred to as an “element for data”.

By reproducing data using a reproducing element having a narrow reproducing element width as a reproducing element, data recorded at high-density can be reproduced with high sensitivity. From this viewpoint, the reproducing element width of the reproducing element is preferably 0.8 μm or less. The reproducing element width of the reproducing element may be, for example, 0.3 μm or more. Note that it is also preferable to be lower than this value from the above viewpoint.

On the other hand, as the reproducing element width becomes narrower, a phenomenon such as reproduction failure due to off-track is more likely to occur. In order to suppress occurrence of such a phenomenon, the magnetic tape apparatus that controls the dimension in the width direction of the magnetic tape by adjusting the tension applied in the longitudinal direction of the magnetic tape is preferable.

Here, the term “reproducing element width” means a physical dimension of the reproducing element width. Such a physical dimension can be measured by an optical microscope, a scanning electron microscope, or the like.

In a case of recording data and/or reproducing recorded data, first, tracking using the servo signal can be performed. That is, by causing the servo signal reading element to follow a predetermined servo track, the element for data can be controlled to pass on the target data track. Displacement of the data track is performed by changing a servo track read by the servo signal reading element in a tape width direction.

The recording and reproducing head can also perform recording and/or reproduction with respect to other data bands. In this case, the servo signal reading element need only be displaced to a predetermined servo band using the above described UDIM information to start tracking for the servo band.

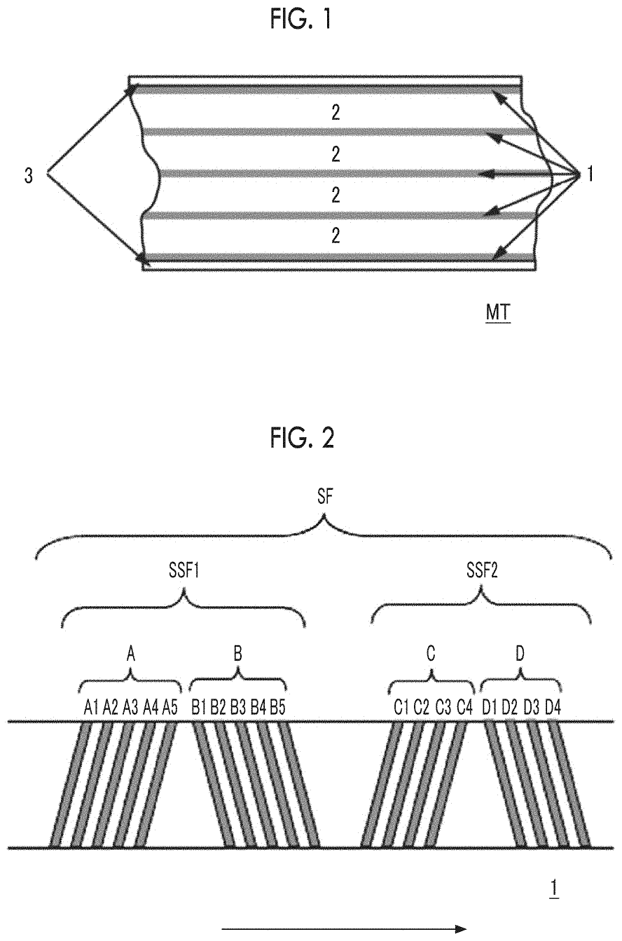

FIG. 1 shows an arrangement example of the data band and the servo band. In FIG. 1, in the magnetic layer of a magnetic tape MT, a plurality of servo bands 1 are arranged so as to be interposed between guide bands 3. A plurality of regions 2 interposed between two servo bands are data bands. The servo pattern is a magnetization region, and is formed by magnetizing a specific region of the magnetic layer by the servo write head. A region magnetized by the servo write head (a position where the servo pattern is formed) is determined by the standard. For example, in an LTO Ultrium format tape which is based on a local standard, a plurality of servo patterns inclined with respect to a tape width direction as shown in FIG. 2 are formed on a servo band, in a case of manufacturing a magnetic tape. Specifically, in FIG. 2, a servo frame SF on the servo band 1 is composed of a servo sub-frame 1 (SSF1) and a servo sub-frame 2 (SSF2). The servo sub-frame 1 is composed of an A burst (in FIG. 2, reference numeral A) and a B burst (in FIG. 2, reference numeral B). The A burst is composed of servo patterns A1 to A5 and the B burst is composed of servo patterns B1 to B5. Meanwhile, the servo sub-frame 2 is composed of a C burst (in FIG. 2, reference numeral C) and a D burst (in FIG. 2, reference numeral D). The C burst is composed of servo patterns C1 to C4 and the D burst is composed of servo patterns D1 to D4. Such 18 servo patterns are arranged in the sub-frames in an array of 5, 5, 4, 4, as the sets of 5 servo patterns and 4 servo patterns, and are used for identifying the servo frames. FIG. 2 shows one servo frame for description. In practice, however, a plurality of the servo frames are arranged in the running direction in each servo band in the magnetic layer of the magnetic tape on which the head tracking of the timing-based servo system is performed. In FIG. 2, an arrow shows a running direction. For example, an LTO Ultrium format tape usually has 5000 or more servo frames per 1 m of tape length in each servo band of the magnetic layer.

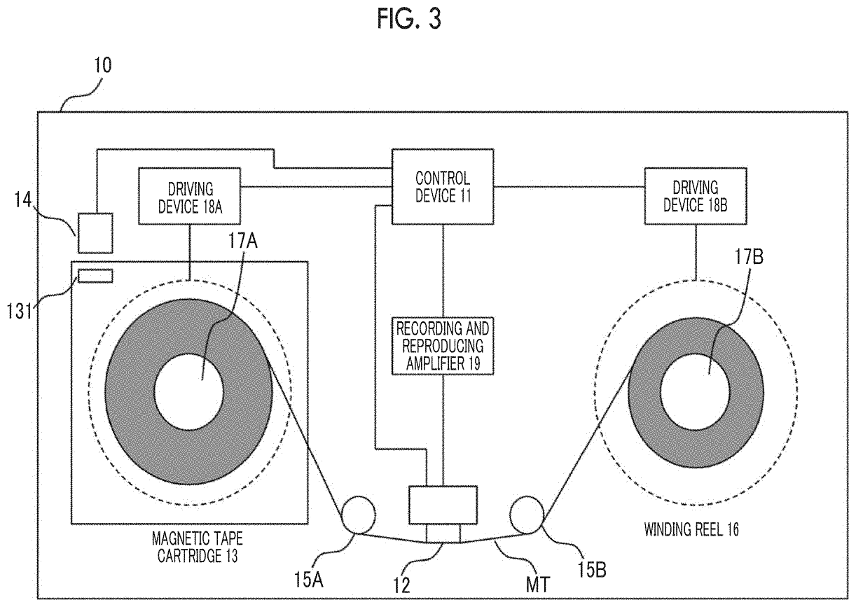

The magnetic tape apparatus may have a tension adjusting mechanism capable of adjusting the tension applied in the longitudinal direction of the magnetic tape running in the magnetic tape apparatus. Such a tension adjusting mechanism can variably control the tension applied in the longitudinal direction of the magnetic tape, and can preferably control the dimension in the width direction of the magnetic tape by adjusting the tension applied in the longitudinal direction of the magnetic tape. In the above tension adjustment, the tension applied in the longitudinal direction of the magnetic tape may change. An example of such a magnetic tape apparatus will be described below with reference to FIG. 3. However, the present invention is not limited to the example shown in FIG. 3.

Configuration of Magnetic Tape Apparatus

A magnetic tape apparatus 10 shown in FIG. 3 controls a recording and reproducing head unit 12 in accordance with an instruction from a control device 11, and records and reproduces data on a magnetic tape MT.

The magnetic tape apparatus 10 has a configuration capable of detecting and adjusting the tension applied in the longitudinal direction of the magnetic tape from spindle motors 17A and 17B for controlling rotation of a magnetic tape cartridge reel and a winding reel and driving devices 18A and 18B thereof.

The magnetic tape apparatus 10 has a configuration capable of loading a magnetic tape cartridge 13.

The magnetic tape apparatus 10 has a cartridge memory reading and writing device 14 capable of reading and writing a cartridge memory 131 in the magnetic tape cartridge 13.

From the magnetic tape cartridge 13 mounted on the magnetic tape apparatus 10, an end portion or a leader pin of the magnetic tape MT is pulled out by an automatic loading mechanism or a manual operation, and the magnetic layer surface of the magnetic tape MT passes on the recording and reproducing head through guide rollers 15A and 15B in a direction contacting with a recording and reproducing head surface of the recording and reproducing head unit 12, and thus the magnetic tape MT is wound around a winding reel 16.

The rotation and torque of the spindle motor 17A and the spindle motor 17B are controlled by a signal from the control device 11, and the magnetic tape MT is run at any speed and tension. A servo pattern previously formed on the magnetic tape can be used to control the tape speed. In order to detect the tension, a tension detecting mechanism may be provided between the magnetic tape cartridge 13 and the winding reel 16. The tension may be controlled by using the guide rollers 15A and 15B in addition to the control by the spindle motors 17A and 17B.

The cartridge memory reading and writing device 14 is configured to be capable of reading out and writing information in the cartridge memory 131 in response to an instruction from the control device 11. As a communication method between the cartridge memory reading and writing device 14 and the cartridge memory 131, for example, an international organization for standardization (ISO) 14443 method can be employed.

The control device 11 includes, for example, a control unit, a storage unit, a communication unit, and the like.

The recording and reproducing head unit 12 includes, for example, a recording and reproducing head, a servo tracking actuator that adjusts a position of the recording and reproducing head in the track width direction, a recording and reproducing amplifier 19, a connector cable for connection with the control device 11, and the like. The recording and reproducing head includes, for example, a recording element for recording data on the magnetic tape, a reproducing element for reproducing data on the magnetic tape, and a servo signal reading element for reading a servo signal recorded on the magnetic tape. For example, one or more recording elements, reproducing elements, and servo signal reading elements are mounted in one magnetic head. Alternatively, each element may be separately provided in a plurality of magnetic heads according to the running direction of the magnetic tape.

The recording and reproducing head unit 12 is configured to be capable of recording data on the magnetic tape MT in response to an instruction from the control device 11. In addition, the recording and reproducing head unit 12 is configured to be capable of reproducing the data recorded on the magnetic tape MT is configured to be able to be reproduced in response to an instruction from the control device 11.

The control device 11 has a mechanism for obtaining the running position of the magnetic tape from the servo signal read from the servo band in a case where the magnetic tape MT is run, and controlling the servo tracking actuator such that the recording element and/or the reproducing element is located at a target running position (track position). The track position is controlled by feedback control, for example. The control device 11 has a mechanism for obtaining a servo band interval from servo signals read from two adjacent servo bands in a case where the magnetic tape MT is run. In addition, the control device 11 has a mechanism for controlling the torque of the spindle motor 17A and the spindle motor 17B and/or the guide rollers 15A and 15B to control the tension in the longitudinal direction of the magnetic tape such that the servo band interval becomes a target value. The tension is controlled by feedback control, for example. In addition, the control device 11 can store the obtained information on the servo band interval in the storage unit inside the control device 11, the cartridge memory 131, an external connection device, or the like.

### EXAMPLES

Hereinafter, the present invention will be described based on Examples. Here, the present invention is not limited to aspects shown in Examples. The term “part” described below indicates “part by mass”. The processes and evaluations in the following description were performed in an environment of a temperature of 23° C. t 1° C., unless otherwise noted. “eq” in the following description is an equivalent and is a unit that cannot be converted into SI unit.

Protrusion Forming Agent

A protrusion forming agent used in preparation of a magnetic layer forming composition for manufacturing magnetic tapes of Examples or Comparative Examples is as follows. A protrusion forming agent A and a protrusion forming agent C are particles having a low surface smoothness of the particle surface. A particle shape of a protrusion forming agent B is a cocoon shape. A particle shape of a protrusion forming agent D is a so-called amorphous. A particle shape of a protrusion forming agent E is a shape close to a true sphere.

Protrusion forming agent A: ATLAS (composite particle of silica and polymer) manufactured by Cabot Corporation, average particle size of 100 nm

Protrusion forming agent B: TGC6020N (silica particle) manufactured by Cabot Corporation, average particle size of 140 nm

Protrusion forming agent C: Cataloid (an aqueous dispersion sol of a silica particle; as a protrusion forming agent for preparing a back coating layer forming composition, a dry solid obtained by heating the aqueous dispersion sol to remove a solvent is used) manufactured by JGC Catalysts Co., Ltd., average particle size of 120 nm

Protrusion forming agent D: Asahi #52 (carbon black) manufactured by Asahi Carbon Co., Ltd., average particle size of 60 nm

Protrusion forming agent E: Quartron PL-10L (an aqueous dispersion sol of a silica particle; as a protrusion forming agent for preparing a back coating layer forming composition, a dry solid obtained by heating the aqueous dispersion sol to remove a solvent is used) manufactured by Fuso Chemical Industry Co., Ltd., average particle size of 130 nm

Ferromagnetic Powder

in Table 1, “BaFe” is a hexagonal barium ferrite powder (coercivity Hc: 196 kA/m, average particle size (average plate diameter) of 24 nm).

In Table 1, “SrFe1” is a hexagonal strontium ferrite powder manufactured by the following method.

1707 g of SrCO₃, 687 g of H3B03, 1120 g of Fe₂O₃, 45 g of Al(OH)₃, 24 g of BaCO₃, 13 g of CaCO₃, and 235 g of Nd₂O₃ were weighed and mixed by a mixer to obtain a raw material mixture.

The obtained raw material mixture was melted in a platinum crucible at a melting temperature of 1390° C., and a hot water outlet provided at a bottom of the platinum crucible was heated while stirring a melt, and the melt was discharged in a rod shape at about 6 g/sec. Hot water was rolled and quenched by a pair of water-cooling rollers to manufacture an amorphous body.

280 g of the manufactured amorphous body was charged into an electric furnace, was heated to 635° C. (crystallization temperature) at a heating rate of 3.5° C./min, and was kept at the same temperature for 5 hours to precipitate (crystallize) hexagonal strontium ferrite particles.

Next, a crystallized product obtained above including hexagonal strontium ferrite particles was coarsely pulverized in a mortar, and 1000 g of zirconia beads having a particle diameter of 1 mm and 800 ml of an acetic acid aqueous solution of 1% concentration were added to the crystallized product in a glass bottle, to be dispersed by a paint shaker for 3 hours. Thereafter, the obtained dispersion liquid was separated from the beads, to be put in a stainless beaker. The dispersion liquid was statically left at a liquid temperature of 100° C. for 3 hours and subjected to a dissolving treatment of a glass component, and then the crystallized product was sedimented by a centrifugal separator to be washed by repeatedly performing decantation and was dried in a heating furnace at an internal temperature of the furnace of 110° C. for 6 hours to obtain a hexagonal strontium ferrite powder.

An average particle size of the hexagonal strontium ferrite powder obtained above was 18 nm, an activation volume was 902 nm³, an anisotropy constant Ku was 2.2×10¹ J/m³, and a mass magnetization as was 49 A m²/kg.

12 mg of a sample powder was taken from the hexagonal strontium ferrite powder obtained above, elemental analysis of the filtrated solution obtained by partially dissolving this sample powder under dissolution conditions illustrated above was performed by an ICP analyzer, and a surface layer portion content of a neodymium atom was determined.

Separately, 12 mg of a sample powder was taken from the hexagonal strontium ferrite powder obtained above, elemental analysis of the filtrated solution obtained by totally dissolving this sample powder under dissolution conditions illustrated above was performed by an ICP analyzer, and a bulk content of a neodymium atom was determined.

A content (bulk content) of a neodymium atom with respect to 100 at % of an iron atom in the hexagonal strontium ferrite powder obtained above was 2.9 at %. A surface layer portion content of a neodymium atom was 8.0 at %. It was confirmed that a ratio between a surface layer portion content and a bulk content, that is, “surface layer portion content/bulk content” was 2.8, and a neodymium atom was unevenly distributed in a surface layer of a particle.

The fact that the powder obtained above shows a crystal structure of hexagonal ferrite was confirmed by performing scanning with CuKα rays under conditions of a voltage of 45 kV and an intensity of 40 mA and measuring an X-ray diffraction pattern under the following conditions (X-ray diffraction analysis). The powder obtained above showed a crystal structure of hexagonal ferrite of a magnetoplumbite type (M type). A crystal phase detected by X-ray diffraction analysis was a single phase of a magnetoplumbite type.
PANalytical X'Pert Pro diffractometer, PIXcel detector
Soller slit of incident beam and diffracted beam: 0.017 radians
Fixed angle of dispersion slit: ¼ degrees
Mask: 10 mm
Anti-scattering slit: ¼ degrees
Measurement mode: continuous
Measurement time per stage: 3 seconds
Measurement speed: 0.017 degrees per second
Measurement step: 0.05 degrees

In Table 1, “SrFe2” is a hexagonal strontium ferrite powder manufactured by the following method.

1725 g of SrCO₃, 666 g of H₃BO₃, 1332 g of Fe₂O₃, 52 g of Al(OH)₃, 34 g of CaCO₃, and 141 g of BaCO₃ were weighed and mixed by a mixer to obtain a raw material mixture.

The obtained raw material mixture was melted in a platinum crucible at a melting temperature of 1380° C., and a hot water outlet provided at a bottom of the platinum crucible was heated while stirring a melt, and the melt was discharged in a rod shape at about 6 g/sec. Hot water was rolled and quenched by a pair of water-cooling rollers to manufacture an amorphous body.

280 g of the obtained amorphous body was charged into an electric furnace, was heated to 645° C. (crystallization temperature), and was kept at the same temperature for 5 hours to precipitate (crystallize) hexagonal strontium ferrite particles.

Next, a crystallized product obtained above including hexagonal strontium ferrite particles was coarsely pulverized in a mortar, and 1000 g of zirconia beads having a particle diameter of 1 mm and 800 ml of an acetic acid aqueous solution of 1% concentration were added to the crystallized product in a glass bottle, to be dispersed by a paint shaker for 3 hours. Thereafter, the obtained dispersion liquid was separated from the beads, to be put in a stainless beaker. The dispersion liquid was statically left at a liquid temperature of 100° C. for 3 hours and subjected to a dissolving treatment of a glass component, and then the crystallized product was sedimented by a centrifugal separator to be washed by repeatedly performing decantation and was dried in a heating furnace at an internal temperature of the furnace of 110° C. for 6 hours to obtain a hexagonal strontium ferrite powder.

An average particle size of the obtained hexagonal strontium ferrite powder was 19 nm, an activation volume was 1102 nm³, an anisotropy constant Ku was 2.0×10⁵ J/m³, and a mass magnetization as was 50 A·m²/kg.

In Table 1, “ε-iron oxide” is an ε-iron oxide powder manufactured by the following method.

8.3 g of iron(III) nitrate nonahydrate, 1.3 g of gallium(III) nitrate octahydrate, 190 mg of cobalt(II) nitrate hexahydrate, 150 mg of titanium(IV) sulfate, and 1.5 g of polyvinylpyrrolidone (PVP) were dissolved in 90 g of pure water, and while the dissolved product was stirred using a magnetic stirrer, 4.0 g of an aqueous ammonia solution having a concentration of 25% was added to the dissolved product under a condition of an atmosphere temperature of 25° C. in an air atmosphere, and the dissolved product was stirred for 2 hours while maintaining a temperature condition of the atmosphere temperature of 25° C. A citric acid solution obtained by dissolving 1 g of citric acid in 9 g of pure water was added to the obtained solution, and the mixture was stirred for 1 hour. The powder sedimented after stirring was collected by centrifugal separation, was washed with pure water, and was dried in a heating furnace at a furnace temperature of 80° C.

800 g of pure water was added to the dried powder, and the powder was dispersed again in water to obtain dispersion liquid. The obtained dispersion liquid was heated to a liquid temperature of 50° C., and 40 g of an aqueous ammonia solution having a concentration of 25% was dropwise added with stirring. After stirring for 1 hour while maintaining the temperature at 50° C., 14 mL of tetraethoxysilane (TEOS) was dropwise added and was stirred for 24 hours. A powder sedimented by adding 50 g of ammonium sulfate to the obtained reaction solution was collected by centrifugal separation, was washed with pure water, and was dried in a heating furnace at a furnace temperature of 80° C. for 24 hours to obtain a ferromagnetic powder precursor.

The obtained ferromagnetic powder precursor was loaded into a heating furnace at a furnace temperature of 1000° C. in an air atmosphere and was heat-treated for 4 hours.

The heat-treated ferromagnetic powder precursor was put into an aqueous solution of 4 mol/L sodium hydroxide (NaOH), and the liquid temperature was maintained at 70° C. and was stirred for 24 hours, whereby a silicic acid compound as an impurity was removed from the heat-treated ferromagnetic powder precursor.

Thereafter, the ferromagnetic powder from which the silicic acid compound was removed was collected by centrifugal separation, and was washed with pure water to obtain a ferromagnetic powder.

The composition of the obtained ferromagnetic powder that was checked by high-frequency inductively coupled plasma-optical emission spectrometry (ICP-OES) has Ga, Co, and a Ti substitution type ε-iron oxide (ε-Ga_{0.28}Co_{0.05}Ti_{0.05}Fe_{1.62}O₃). In addition, X-ray diffraction analysis is performed under the same condition as that described above for SrFe1, and from a peak of an X-ray diffraction pattern, it was confirmed that the obtained ferromagnetic powder does not include α-phase and Y-phase crystal structures, and has a single-phase and ε-phase crystal structure (ε-iron oxide type crystal structure).

The obtained ε-iron oxide powder had an average particle size of 12 nm, an activation volume of 746 nm³, an anisotropy constant Ku of 1.2×10⁵ J/m³, and a mass magnetization as of 16 A m²/kg.

An activation volume and an anisotropy constant Ku of the above hexagonal strontium ferrite powder and ε-iron oxide powder are values obtained by the method described above using a vibrating sample magnetometer (manufactured by Toei Industry Co., Ltd.) for each ferromagnetic powder.

In addition, a mass magnetization as is a value measured at a magnetic field intensity of 15 kOe using a vibrating sample magnetometer (manufactured by Toei Industry Co., Ltd.).

### Example 1

Magnetic Layer Forming Composition

Magnetic Liquid
Ferromagnetic powder (see Table 1): 100.0 parts
Oleic acid: 2.0 parts
Vinyl chloride copolymer (MR-104 manufactured by Kaneka Corporation): 10.0 parts
SO₃Na group-containing polyurethane resin: 4.0 parts (weight-average molecular weight: 70000, SO₃Na group: 0.07 meq/g)
Additive A: 10.0 parts
Methyl ethyl ketone: 150.0 parts
Cyclohexanone: 150.0 parts
Abrasive Liquid
α-Alumina (average particle size: 110 nm): 6.0 parts
Vinyl chloride copolymer (MR110 manufactured by Kaneka Corporation): 0.7 parts
Cyclohexanone: 20.0 parts
Protrusion Forming Agent Liquid
Protrusion Forming Agent (see Table 1): see Table 1 Polyethyleneimine (manufactured by Nippon Shokubai Co., Ltd., number-average molecular weight of 300): see Table 1
Stearic acid: see Table 1
Methyl ethyl ketone: 9.0 parts
Cyclohexanone: 6.0 parts
Other Components
Polyethyleneimine (manufactured by Nippon Shokubai Co., Ltd., number-average molecular weight of 300): see Table 1
Stearic acid: see Table 1
Stearic acid amide: 0.3 parts
Butyl stearate: 6.0 parts
Methyl ethyl ketone: 110.0 parts
Cyclohexanone: 110.0 parts
Polyisocyanate (CORONATE (registered trademark) L manufactured by Tosoh Corporation): 3.0 parts

The above-described additive A is a polymer synthesized by the method disclosed in paragraphs 0115 to 0123 of JP2016-051493A.

Non-Magnetic Layer Forming Composition
Non-magnetic inorganic powder (α-iron oxide): 80.0 parts (average particle size: 0.15 μm, average acicular ratio: 7, brunauer-emmett-teller (BET) specific surface area: 52 m²/g)
Carbon black (average particle size: 20 nm): 20.0 parts
Electron beam curable vinyl chloride copolymer: 13.0 parts
Electron beam curable polyurethane resin: 6.0 parts
Phenylphosphonic acid: 3.0 parts
Cyclohexanone: 140.0 parts
Methyl ethyl ketone: 170.0 parts
Butyl stearate: 2.0 parts
Stearic acid: 1.0 part

Back Coating Layer Forming Composition
Non-magnetic inorganic powder (α-iron oxide): 80.0 parts (average particle size: 0.15 μm, average acicular ratio: 7, BET specific surface area: 52 m²/g)
Carbon black (average particle size: 20 nm): 20.0 parts
Carbon black (average particle size: 100 nm): 3.0 parts
Vinyl chloride copolymer: 13.0 parts
Sulfonic acid group-containing polyurethane resin: 6.0 parts
Phenylphosphonic acid: 3.0 parts
Cyclohexanone: 140.0 parts
Methyl ethyl ketone: 170.0 parts
Stearic acid: 3.0 parts
Polyisocyanate (CORONATE (registered trademark) L manufactured by Tosoh Corporation): 5.0 parts
Methyl ethyl ketone: 400.0 parts

Preparation of Each Layer Forming Composition

A magnetic layer forming composition was prepared by the following method.

The components of the magnetic liquid were kneaded and diluted by an open kneader, and then subjected to a dispersion treatment of 12 passes, with a horizontal beads mill dispersing device using zirconia (ZrO₂) beads (hereinafter, referred to as “Zr beads”) having a particle diameter of 0.5 mm, by setting a retention time per pass to 2 minutes at a bead filling rate of 80 vol % and a circumferential speed of a rotor distal end of 10 m/sec.

The components of the abrasive liquid were mixed and then the mixture was put in a vertical sand mill dispersing device together with Zr beads having a particle diameter of 1 mm, and bead volume/(abrasive liquid volume+bead volume) was adjusted to be 60%, and sand mill dispersion treatment was performed for 180 minutes. The liquid after the treatment was taken out and subjected to an ultrasonic dispersion filtration treatment using a flow type ultrasonic dispersion filtration device. The components of the protrusion forming agent liquid were mixed and then the mixture was subjected to an ultrasonic treatment (dispersion treatment) for 60 minutes at an ultrasonic output of 500 watts per 200 cc by a horn type ultrasonic dispersing device, and the obtained dispersion liquid was filtered using a filter having a pore diameter of 0.5 μm. Thereby, a protrusion forming agent liquid was prepared.

The magnetic liquid, the abrasive liquid, the protrusion forming agent liquid, and other components described above were put into a dissolver stirrer and stirred for 30 minutes at a circumferential speed of 10 m/sec. After that, the treatment of 3 passes was performed at a flow rate of 7.5 kg/min by a flow type ultrasonic dispersing device, and then, a magnetic layer forming composition was prepared by filtration using a filter having a pore diameter of 1 μm.

A non-magnetic layer forming composition was prepared by the following method.

The components excluding a lubricant (butyl stearate and stearic acid) were kneaded and diluted by an open kneader, and then subjected to a dispersion treatment by a horizontal beads mill dispersing device. After that, the lubricant (butyl stearate and stearic acid) was added into the obtained dispersion liquid and stirred and mixed by a dissolver stirrer to prepare a non-magnetic layer forming composition.

A back coating layer forming composition was prepared by the following method.

The components excluding a lubricant (stearic acid), polyisocyanate, and methyl ethyl ketone (400.0 parts) were kneaded and diluted by an open kneader, and then subjected to a dispersion treatment by a horizontal beads mill dispersing device. After that, the lubricant (stearic acid), polyisocyanate, and methyl ethyl ketone (400.0 parts) were added into the obtained dispersion liquid and stirred and mixed by a dissolver stirrer to prepare a back coating layer forming composition.

Manufacturing of Magnetic Tape and Magnetic Tape Cartridge

The non-magnetic layer forming composition was applied onto a biaxially stretched polyethylene naphthalate support having a thickness of 4.2 μm and dried so that the thickness after drying was 0.7 μm, and then, an electron beam was emitted at an acceleration voltage of 125 kV to obtain an energy of 40 kGy. The magnetic layer forming composition was applied thereonto and dried so that the thickness after drying was 0.1 μm, and further, the back coating layer forming composition was applied onto a surface of the support opposite to the surface on which the non-magnetic layer and the magnetic layer are formed and dried, so that the thickness after drying was 0.3 μm.

After that, a calendering treatment was performed using a 7-stage calender roll formed of only a metal roll at a calender speed of 80 m/min, a linear pressure of 294 kN/m, and a calender temperature (surface temperature of calender roll) of 80° C. After that, a heat treatment was performed for 36 hours in an environment of an atmosphere temperature of 70° C. After the heat treatment, slitting was performed to have ½ inches width, and the magnetic layer surface was cleaned with a tape cleaning device in which a non-woven fabric and a razor blade are attached to a device including a feeding and winding device of the slit so as to press the magnetic layer surface. Thereby, a magnetic tape was obtained.

A servo signal was recorded on the magnetic layer of the obtained magnetic tape by a commercially available servo writer to obtain a magnetic tape having a data band, a servo band, and a guide band in an arrangement according to a linear tape-open (LTO) Ultrium format and having a servo pattern (timing-based servo pattern) in an arrangement and a shape according to the LTO Ultrium format on the servo band. The servo pattern thus formed is a servo pattern according to the description in Japanese industrial standards (JIS) X6175:2006 and Standard ECMA-319 (June 2001). The total number of servo bands is 5, and the total number of data bands is 4. The magnetic tape (length of 960 m) on which the servo signal is recorded was wound around a reel of a magnetic tape cartridge (LTO Ultrium 8 data cartridge).

In this way, the magnetic tape cartridge of Example 1 in which the magnetic tape was wound on a reel was manufactured.

It could be confirmed by the following method that the magnetic layer of the magnetic tape includes a compound formed of polyethyleneimine and stearic acid and including the ammonium salt structure of the alkyl ester anion represented by Formula 1.

A sample was cut out from the magnetic tape, and X-ray photoelectron spectroscopy analysis is performed on the magnetic layer surface (measurement area: 300 μm×700 μm) using an ESCA device. Specifically, the wide scanning measurement was performed by the ESCA device under the following measurement conditions. In measurement results, peaks were confirmed at a binding energy position of an ester anion and a binding energy position of an ammonium cation.
Device: AXIS-ULTRA manufactured by Shimadzu Corporation
Excited X-ray source: monochromatic Al-Kα ray
Scanning range: 0 to 1,200 eV
Pass energy: 160 eV
Energy resolution: 1 eV/step
Take-in time: 100 ms/step
Accumulation number: 5

In addition, a sample piece having a length of 3 cm was cut out from the magnetic tape, and the attenuated total reflection-fourier transform-infrared spectrometer (ATR-FT-IR) measurement (reflection method) was performed on the magnetic layer surface. In measurement results, an absorption was confirmed at the wave number (1540 cm⁻¹ or 1430 cm⁻¹) corresponding to an absorption of COO⁻ and the wave number (2400 cm⁻¹) corresponding to an absorption of an ammonium cation.

Examples 2 to 10 and Comparative Examples 1 to 5

A magnetic tape and a magnetic tape cartridge were obtained by the same method as in Example 1 except that the items shown in Table 1 were changed as shown in Table 1.

For each of the examples and comparative examples, two magnetic tape cartridges were prepared, one for evaluation of the following running stability and the other for evaluation of the following magnetic tape.

Evaluation of Running Stability

In an environment of a temperature of 32° C. and a relative humidity of 80%, running stability was evaluated by the following method.

Using each magnetic tape cartridge of Examples and the Comparative Examples, recording and reproduction of data were performed using a magnetic tape apparatus having the configuration shown in FIG. 3. The recording and reproducing head mounted on the recording and reproducing head unit had 32 or more channels of a reproducing element (reproducing element width: 0.8 μm) and a recording element, and had servo signal reading elements on both sides thereof.

Data was recorded and reproduced by the following method, and the running stability during reproduction was evaluated.

The magnetic tape cartridge was set in the magnetic tape apparatus and the magnetic tape was loaded. Next, pseudo random data having a specific data pattern was recorded on the magnetic tape by the recording and reproducing head unit while performing servo tracking. In this case, the tension applied in the tape longitudinal direction was set to a constant value. Simultaneously with the recording of the data, the value of the servo band interval of the tape total length was measured at every 1 m of the longitudinal position and recorded in the cartridge memory.

Then, the data recorded on the magnetic tape was reproduced by the recording and reproducing head unit while performing servo tracking. In this case, the value of the servo band interval was measured simultaneously with the reproduction, and the tension applied in the tape longitudinal direction was controlled such that an absolute value of a difference from the servo band interval during recording at the same longitudinal position approaches 0 based on information recorded in the cartridge memory. During reproduction, measurement of the servo band interval and tension control based on the measurement were continuously performed in real time. During such reproduction, the tension applied in the longitudinal direction of the magnetic tape changed depending on the control device of the magnetic tape apparatus.

After that, in the magnetic tape apparatus, the data recording region of the magnetic tape was reciprocatively slid 3000 times with respect to the recording and reproducing head, and then the magnetic tape cartridge accommodating the magnetic tape after the reciprocating slide therein was stored in an environment of a temperature of 32° C. and a relative humidity of 80% for 24 hours.

Within 1 hour after the storage, the data recorded on the magnetic tape was reproduced in the environment of the temperature of 32° C. and the relative humidity of 80% in the same manner as the reproduction before the storage in the magnetic tape apparatus in which the reproduction before the storage has been performed. The running stability was evaluated using, as an index, a standard deviation (hereinafter, referred to as “σPES”) of a reading position error signal (PES) in the width direction based on the servo signal obtained by the servo signal reading element during the reproduction after the storage.

The PES was obtained by the following method.

In order to obtain the PES, the dimensions of the servo pattern are required. The standards of the dimensions of the servo pattern depend on the generation of LTO. First, an average distance AC between four stripes corresponding to an A burst and a C burst and an azimuth angle α of the servo pattern were measured by using a magnetic force microscope or the like.

An average time between five stripes corresponding to the A burst and the B burst over a length of one LPOS word was defined as a. An average time between four stripes corresponding to the A burst and the C burst over a length of one LPOS word was defined as b. In this case, a value defined by ACx(½-a/b)/(2×tan(α)) represents a reading position PES in the width direction based on the servo signal obtained by the servo signal reading element over a length of one LPOS word. For the magnetic tape, the standard deviation (σPES) of the PES obtained by the above method was calculated for a region in the tape longitudinal direction over a length of 30 m to 200 m, where a terminal on the side wound around the reel of the magnetic tape cartridge is called an inner terminal, a terminal on the opposite side is called an outer terminal, and the outer terminal is set to 0 m. In a case where the σPES is less than 70 nm, it can be determined that the running stability is excellent.

Evaluation of Magnetic Tape

(1) Friction Coefficients μ1 and μ2 and Rate of Change (μ1/μ2) in Friction Coefficient before and after Storage of Magnetic Tape

The magnetic tape was taken out from each magnetic tape cartridge of Examples and Comparative Examples, and in an environment of a temperature of 32° C. and a relative humidity of 80%, the friction coefficient μ1 before storage and the friction coefficient μ2 after storage were obtained by the method described above. As the LTO8 head, a commercially available LTO8 head (manufactured by IBM Corporation) was used. From the obtained μ1 and μ2, the rate of change (μ1/μ2) in friction coefficient before and after storage of the magnetic tape was calculated.

(2) Tape Thickness

Ten tape samples (length of 5 cm) were cut out from any part of the magnetic tape taken out from each magnetic tape cartridge of Examples and Comparative Examples, and the thickness was measured by stacking these tape samples. The thickness was measured using a digital thickness gauge of Millimar 1240 compact amplifier and Millimar 1301 induction probe manufactured by Mahr Inc. A value (thickness per tape sample) obtained by dividing the measured thickness by 1/10 was defined as the tape thickness. Each magnetic tape had a thickness of 5.3 μm.

The above results are shown in Table 1.

TABLE 1

| | | | | | | | | | | Rate of | |
|---|---|---|---|---|---|---|---|---|---|---|---|
| | Magnetic layer forming composition | | | | | | | | | change in | |
| | | Poly- | | | | | | | | friction | |
| | | ethyl- | | | | | | | | coefficient | |
| | Ferro- | eneimine | Stearic acid | Protrusion forming agent liquid | | | | | | before and | |
| | magnetic | (as other | (as other | | | Poly- | Stearic | Friction | | after | |
| | powder | components) | components) | Protrusion forming agent | | ethyleneimine | acid | coefficient | | storage | σPES |
| | Type | Amount | Amount | Type | Amount | Amount | Amount | μ1 | μ2 | (μ1/μ2) | nm |
| Example 1 | BaFe | 2.0 parts | 0.5 parts | Protrusion | 1.0 part | 0.03 parts | 0.07 parts | 0.6 | 0.7 | 0.9 | 50 |
| | | | | forming agent D | | | | | | | |
| Example 2 | BaFe | 2.0 parts | 0.5 parts | Protrusion | 1.0 part | 0.07 parts | 0.13 parts | 0.5 | 0.6 | 0.8 | 55 |
| | | | | forming agent D | | | | | | | |
| Example 3 | BaFe | 2.0 parts | 0.5 parts | Protrusion | 1.0 part | 0.10 parts | 0.20 parts | 0.5 | 0.6 | 0.8 | 50 |
| | | | | forming agent D | | | | | | | |
| Example 4 | BaFe | 2.0 parts | 0.5 parts | Protrusion | 1.0 part | 0.03 parts | 0.07 parts | 0.5 | 0.7 | 0.7 | 55 |
| | | | | forming agent A | | | | | | | |
| Example 5 | BaFe | 2.0 parts | 0.5 parts | Protrusion | 1.0 part | 0.03 parts | 0.07 parts | 0.5 | 0.7 | 0.7 | 55 |
| | | | | forming agent B | | | | | | | |
| Example 6 | BaFe | 2.0 parts | 0.5 parts | Protrusion | 1.0 part | 0.03 parts | 0.07 parts | 0.5 | 0.7 | 0.7 | 60 |
| | | | | forming agent C | | | | | | | |
| Example 7 | BaFe | 2.0 parts | 0.5 parts | Protrusion | 0.5 parts | 0.02 parts | 0.03 parts | 0.7 | 0.9 | 0.8 | 65 |
| | | | | forming agent A | | | | | | | |
| Example 8 | SrFe1 | 2.0 parts | 0.5 parts | Protrusion | 1.0 part | 0.03 parts | 0.07 parts | 0.6 | 0.7 | 0.9 | 50 |
| | | | | forming agent D | | | | | | | |
| Example 9 | SrFe2 | 2.0 parts | 0.5 parts | Protrusion | 1.0 part | 0.03 parts | 0.07 parts | 0.6 | 0.7 | 0.9 | 55 |
| | | | | forming agent D | | | | | | | |
| Example 10 | ε-Iron | 2.0 parts | 0.5 parts | Protrusion | 1.0 part | 0.03 parts | 0.07 parts | 0.6 | 0.7 | 0.9 | 50 |
| | oxide | | | forming agent D | | | | | | | |
| Comparative | BaFe | None | 0.5 parts | Protrusion | 1.0 part | None | None | 0.5 | 1.0 | 0.5 | 85 |
| Example 1 | | | | forming agent E | | | | | | | |
| Comparative | BaFe | 2.0 parts | 0.5 parts | Protrusion | 1.0 part | None | None | 0.5 | 0.9 | 0.6 | 80 |
| Example 2 | | | | forming agent E | | | | | | | |
| Comparative | BaFe | 2.0 parts | 0.5 parts | Protrusion | 1.0 part | None | None | 0.5 | 0.8 | 0.6 | 80 |
| Example 3 | | | | forming agent D | | | | | | | |
| Comparative | BaFe | 2.0 parts | 0.5 parts | Protrusion | 2.0 parts | None | None | 0.4 | 0.8 | 0.5 | 75 |
| Example 4 | | | | forming agent D | | | | | | | |
| Comparative | BaFe | 2.0 parts | 0.5 parts | Protrusion | 3.0 parts | None | None | 0.4 | 0.7 | 0.6 | 80 |
| Example 5 | | | | forming agent D | | | | | | | |

From the results shown in Table 1, it can be confirmed that the magnetic tape of Examples in which the rate of change (μ1/μ2) in friction coefficient before and after storage of the magnetic tape, which is measured in an environment of a temperature of 32° C. and a relative humidity of 80%, is 0.7 or more is a magnetic tape which can exhibit excellent running stability in a short period of time after repeated running in a magnetic tape apparatus that controls the dimension in the width direction of the magnetic tape by adjusting the tension applied in the longitudinal direction of the magnetic tape. The present inventor supposes that this result is contributed by the fact that the magnetic tape of Examples was able to bring the friction coefficient increased by repeated running closer to the value before the increase in a short period of time.

A magnetic tape cartridge was manufactured in the same manner as in Example 1 except that, in a case of manufacturing a magnetic tape, a coating layer was formed by applying the magnetic layer forming composition, and then, while the coating layer was in a wet state, a magnetic field having a magnetic field intensity of 0.3 T was applied in the vertical direction with respect to the surface of the coating layer to perform a vertical alignment treatment and then dried to form a magnetic layer.

A sample piece was cut out from the magnetic tape taken out from the magnetic tape cartridge. For this sample piece, a vertical squareness ratio was obtained by the method described above using a TM-TRVSM5050-SMSL type manufactured by Tamakawa Co., Ltd. as a vibrating sample magnetometer, which was 0.60.

The magnetic tape was also taken out from the magnetic tape cartridge of Example 1, and a vertical squareness ratio was similarly determined for a sample piece cut out from the magnetic tape, which was 0.55.

Each of the magnetic tapes taken out from the above two magnetic tape cartridges was attached to a reel tester having ½ inches, and the electromagnetic conversion characteristics (Signal-to-Noise Ratio (SNR)) were evaluated by the following method. As a result, the magnetic tape manufactured by performing the vertical alignment treatment had a higher SNR value by 2 dB than the magnetic tape of Example 1 manufactured without the vertical alignment treatment.

In an environment of a temperature of 23° C. and a relative humidity of 50%, a tension of 0.7 N was applied in the longitudinal direction of the magnetic tape, and recording and reproduction were performed for 10 passes. A relative speed between the magnetic tape and the magnetic head was set to 6 m/sec. and recording was performed by using a metal-in-gap (MIG) head (a gap length of 0.15 μm and a track width of 1.0 μm) as a recording head and setting a recording current to an optimal recording current of each magnetic tape. Reproduction was performed by using a giant-magnetoresistive (GMR) head (an element thickness of 15 nm, a shield interval of 0.1 μm, and a reproducing element width of 0.8 μm) as a reproducing head. A signal having a linear recording density of 300 kfci was recorded, and measurement regarding a reproduction signal was performed with a spectrum analyzer manufactured by Shibasoku Co., Ltd. The unit kfci is a unit of a linear recording density (cannot be converted into an SI unit system). As the signal, a portion where the signal was sufficiently stable after start of the running of the magnetic tape was used.

An aspect of the present invention is useful in various data storage technical fields.

What is claimed is:

1. A magnetic tape comprising:
a non-magnetic support, and
a magnetic layer including a ferromagnetic powder,
wherein a rate of change in friction coefficient on an LTO8 head measured on a surface of the magnetic layer before and after storage of the magnetic tape, μ1/μ2, is 0.7 or more,
μ1 is a friction coefficient on an LTO8 head in a forward path during 10th reciprocating slide in a case where the magnetic tape is reciprocatively slid 3000 times with respect to the LTO8 head by applying a tension of 2.0 N in a longitudinal direction of the magnetic tape in an environment of a temperature of 32° C. and a relative humidity of 80%, and
μ2 is a friction coefficient on an LTO8 head in a forward path during 10th reciprocating slide in a case where the magnetic tape after the reciprocating slide of 3000 times is stored in the environment of the temperature of 32° C. and the relative humidity of 80% for 24 hours and then is reciprocatively slid 10 times with respect to the LTO8 head by applying the tension of 2.0 N in the longitudinal direction of the magnetic tape in the environment of the temperature of 32° C. and the relative humidity of 80%.

2. The magnetic tape according to claim 1,
wherein μ1/μ2 is 0.7 or more and 1.0 or less.

3. The magnetic tape according to claim 1,
wherein the magnetic layer further includes an inorganic oxide-based particle.

4. The magnetic tape according to claim 1,
wherein the magnetic layer further includes carbon black.

5. The magnetic tape according to claim 1, further comprising:
a non-magnetic layer including a non-magnetic powder between the non-magnetic support and the magnetic layer.

6. The magnetic tape according to claim 1, further comprising:
a back coating layer including a non-magnetic powder on a surface side of the non-magnetic support opposite to a surface side having the magnetic layer.

7. The magnetic tape according to claim 1,
wherein a tape thickness is 5.3 μm or less.

8. The magnetic tape according to claim 2,
wherein a tape thickness is 5.3 μm or less.

9. The magnetic tape according to claim 1,
wherein a vertical squareness ratio is 0.60 or more.

10. The magnetic tape according to claim 2,
wherein a vertical squareness ratio is 0.60 or more.

11. The magnetic tape according to claim 7,
wherein a vertical squareness ratio is 0.60 or more.

12. The magnetic tape according to claim 8,
wherein a vertical squareness ratio is 0.60 or more.

13. A magnetic tape cartridge comprising:
the magnetic tape according to claim 1.

14. A magnetic tape apparatus comprising:
the magnetic tape according to claim 1.

15. The magnetic tape apparatus according to claim 14, further comprising:
a tension adjusting mechanism capable of adjusting the tension applied in the longitudinal direction of the magnetic tape running in the magnetic tape apparatus.
